(19) United States
(12) Patent Application Publication
(10) Pub. No.: US 2023/0300623 A1
(43) Pub. Date: Sep. 21, 2023

(54) Data Translation to Common Format Based on Context

(71) Applicant: ARRIS Enterprises LLC, Suwanee, GA (US)

(72) Inventor: Andrew Barnes, Alton (GB)

(73) Assignee: ARRIS Enterprises LLC, Suwanee, GA (US)

(21) Appl. No.: 18/122,746

(22) Filed: Mar. 17, 2023

Related U.S. Application Data
(60) Provisional application No. 63/321,826, filed on Mar. 21, 2022.

(51) Int. Cl. H04W 12/72; H04W 12/71

(52) U.S. Cl. CPC H04W 12/72; H04W 12/71

(57) ABSTRACT

During operation, a computer system may obtain data associated with an electronic device and that has a first format. Then, the computer system may compute a context of the data. For example, the context may include: a location of the electronic device, a type of the data, a type of the electronic device, the first format, and/or a gateway (such as an access point or a radio node in a network) that forwards the data from the electronic device to the computer system. Moreover, based at least in part on the context, the computer system may identify the electronic device associated with the data. Next, the computer system may translate, based at least in part on the identified electronic device, the data from the first format to a second format, where the second format is common to additional data associated with multiple different types of electronic devices.

### CROSS REFERENCE TO RELATED APPLICATIONS

This application claims priority under 35 U.S.C. 119(e) to U.S. Provisional Application Ser. No. 63/321,826, “Data Translation to Common Format Based on Context,” filed on Mar. 21, 2022, by Andrew Barnes, the contents of which are herein incorporated by reference.

### FIELD

The described embodiments relate to techniques for translating data from an arbitrary format to a common format based at least in part on a context of the data.

### BACKGROUND

The increasing capabilities of electronic devices are dramatically changing our lives. For example, the processing and communication capabilities of portable electronic devices, such as cellular telephones, provide users with the capabilities of a handheld computer. In conjunction with expanded networks, such as the cellular-telephone networks and the Internet, these capabilities are allowing individuals to: access vast amounts of information; identify and interact with other people, organizations and governments; access information at arbitrary locations; and perform a wide variety of tasks. Collectively, these technologies have resulted in a significant increase in economic activity (such as online financial transactions, which are sometimes referred to as ‘ecommerce’) and productivity, and enable a host of applications that enhance user experiences and quality of life.

Recently, it has been proposed that further advances can be achieved by enhancing the capabilities of other electronic devices, which are pervasive but largely ignored by most users (such as in appliances, infrastructure, transportation, farming, etc.). Notably, by embedding sensors, actuators and communication capabilities in these ‘background’ electronic devices, the so-called ‘Internet of things’ (IoT) can provide a distributed network that facilities the exchange of data, remote sensing and control, and a diverse set of applications that facilitate more direct integration of the physical world into computer-based system. In principle, the IoT offers the promise of highly automated systems that improve efficiency, enhance accuracy and expand economic activity in a diverse set of markets, such as: smart cities, hospitality, retail, education, housing, and manufacturing.

In practice, there are still obstacles to achieving the goals of the IoT. Notably, the IoT marketplace is diverse, with competing commercial entities offering electronic devices, endpoints, networks, middleware and cloud-based platforms and services. Moreover, the marketplace lacks interoperability standards, which restricts communication and the exchange of data among components in these systems.

Consequently, the IoT remains fragmented and siloed, which forces users to purchase additional dedicated equipment (such as separate gateways for electronic devices from different manufacturers and providers, and/or additional network switches to connect to different cloud-based service providers) in an attempt to build integrated solutions. However, these efforts often result in custom and expensive solutions with redundant equipment and limited flexibility, all of which is frustrating to users and limits market traction of the IoT.

### SUMMARY

A computer system that translates data is described. This computer system includes: memory that stores program instructions; and a computation device (such as a processor) that executes the program instructions. During operation, the computer system obtains the data associated with the electronic device, which has a first format. Then, the computer system computes a context of the data. Moreover, based at least in part on the context, the computer system identifies the electronic device associated with the data. Next, the computer system translates, based at least in part on the identified electronic device, the data from the first format to a second format, where the second format is common to additional data associated with multiple different types of electronic devices, and where the additional data is stored in or is associated with the computer system.

Note that the computer system may include an interface circuit that communicates with the electronic device, and the obtaining may include receiving the data associated with the electronic device. Alternatively, the obtaining may include accessing the data in the memory. In some embodiments, the electronic device is at an arbitrary location relative to the computer system and/or the first format includes one of a set of formats (and, more generally, has an arbitrary format). The set of formats may be associated with multiple different communication protocols.

Moreover, the context may include: a location of the electronic device, a type of the data, a type of the electronic device, the first format, and/or a gateway (such as an access point or a radio node in a network) that forwards the data from the electronic device to the computer system.

Furthermore, the identifying may be based at least in part on: an identifier of the electronic device (such as a media access control or MAC address, an international mobile subscriber identity (IMSI) number, etc.), a subset of the data (such as a payload in a packet or a frame), a name of the electronic device, and/or additional data associated with a second electronic device (which is different from the electronic device).

Additionally, the second format may be associated with multiple different applications that provide services based at least in part on the data having the second format.

In some embodiments, the computer system may automatically learn the first format when the electronic device and/or the data have not been previously encountered by the computer system.

Note that the computing, identifying and/or translating may be performed by or using a pretrained model, such as a machine-learning model or a neural network.

Moreover, the translating may include decoding the data.

Additional embodiments provide one or more applications based at least in part on the data in the second format.

Additional embodiments provide one or more user interfaces associated with a given application in the one or more applications.

Another embodiment provides a computer in the computer system that performs the at least some of the aforementioned operations in one or more of the preceding embodiments.

Another embodiment provides a computer-readable storage medium with program instructions for use with the computer or the computer system. When executed by the computer or the computer system, the program instructions cause the computer or the computer system to perform at least some of the aforementioned operations in one or more of the preceding embodiments.

Another embodiment provides a method, which may be performed by the computer or the computer system. This method includes at least some of the aforementioned operations in one or more of the preceding embodiments.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of communication among electronic devices in accordance with an embodiment of the present disclosure.

FIG. 2 is a drawing illustrating an example of functionality of a gateway in FIG. 1 in accordance with an embodiment of the present disclosure.

FIG. 3 is a block diagram illustrating an example of an Internet-of-Things (IoT) services manager of FIG. 1 in accordance with an embodiment of the present disclosure.

FIG. 4 is a block diagram illustrating an example of a software architecture of the services manager of FIGS. 1 and 3 in accordance with an embodiment of the present disclosure.

FIG. 5 is a drawing illustrating an example of an onboarding workflow in accordance with an embodiment of the present disclosure.

FIG. 6 is a drawing illustrating an example of a deployment architecture in accordance with an embodiment of the present disclosure.

FIG. 7 is a flow diagram illustrating an example of a method for translating data using a computer system in FIG. 1 in accordance with an embodiment of the present disclosure.

FIG. 8 is a drawing illustrating an example of communication among the electronic devices in FIG. 1 in accordance with an embodiment of the present disclosure.

FIG. 9 is a drawing illustrating an example of a system architecture in accordance with an embodiment of the present disclosure.

FIG. 10 is a drawing illustrating an example of a system architecture in accordance with an embodiment of the present disclosure,

FIG. 11 is a flow diagram illustrating an example of a method for translating data in accordance with an embodiment of the present disclosure.

FIG. 12 is a drawing illustrating an example of an event logger in accordance with an embodiment of the present disclosure.

FIG. 13 is a drawing illustrating an example of back-end device site screening (BEDSS) in accordance with an embodiment of the present disclosure.

FIG. 14 is a drawing illustrating an example of a user interface in accordance with an embodiment of the present disclosure.

FIG. 15 is a drawing illustrating an example of a user interface in accordance with an embodiment of the present disclosure.

FIG. 16 is a drawing illustrating an example of a user interface in accordance with an embodiment of the present disclosure.

FIG. 17 is a drawing illustrating an example of a user interface in accordance with an embodiment of the present disclosure.

FIG. 18 is a drawing illustrating an example of a user interface in accordance with an embodiment of the present disclosure.

FIG. 19 is a drawing illustrating an example of a user interface in accordance with an embodiment of the present disclosure.

FIG. 20 is a drawing illustrating an example of a user interface in accordance with an embodiment of the present disclosure.

FIG. 21 is a drawing illustrating an example of a user interface in accordance with an embodiment of the present disclosure.

FIG. 22 is a drawing illustrating an example of a user interface in accordance with an embodiment of the present disclosure.

FIG. 23 is a drawing illustrating an example of a user interface in accordance with an embodiment of the present disclosure.

FIG. 24 is a block diagram illustrating an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

A computer system that translates data is described. During operation, the computer system may obtain the data associated with an electronic device, which has a first format. Then, the computer system may compute a context of the data. For example, the context may include: a location of the electronic device, a type of the data, a type of the electronic device, the first format, and/or a gateway (such as an access point or a radio node in a network) that forwards the data from the electronic device to the computer system. Moreover, based at least in part on the context, the computer system may identify the electronic device associated with the data. Next, the computer system may translate, based at least in part on the identified electronic device, the data from the first format to a second format, where the second format is common to additional data associated with multiple different types of electronic devices, and where the additional data is stored in or is associated with the computer system.

By translating the data to the second format, these communication techniques may address current obstacles and enable IoT applications and services. Notably, instead of a proprietary or siloed and expensive vertically integrated solution with predefined types of electronic devices at predefined locations, the analysis techniques may allow data associated with a wide variety of different types of electronic devices from different manufacturers and providers that communicate using different formats (such as formats associated with different communication protocols) to be translated into a common format. This common format may enable data aggregation, analysis, decision-making and, thus, a wide variety of applications without requiring a standard, retrofitting of legacy equipment or the use of dedicated equipment. Moreover, the computer system may automatically learn new electronic devices and new first formats. Consequently, in the general case, the data may be associated with an arbitrary electronic device at an arbitrary location. These capabilities may allow different types of data associated with diverse electronic devices from different manufacturers and providers to be dynamically grouped on integrated to provide flexible solutions. Furthermore, these valued-added solutions may be created or generated quickly (or in real-time, such as solutions that can be reconfigured as needed and then provided), with reduced expense and effort relative to existing IoT solutions. Therefore, the communication techniques may improve the user experience when developing or creating solutions or applications, may enhance economic activity, may provide improved services and, thus, may enable the IoT.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth or Bluetooth low energy (BLE), an IEEE 802.15.4 standard, which is sometimes referred to as Zigbee (from the Zigbee Alliance of Davis, California), Z-Wave (from Sigma Designs, Inc. of Fremont, California), LoRaWAN (from the Lora Alliance of Beaverton, Oregon), Thread (from the Thread Group of San Ramon, California), IPv6 over low-power wireless personal area networks or 6LoWPAN (from the Internet Engineering Taskforce of Fremont, California), a cellular-telephone network or data network communication protocol (such as a third generation or 3G communication protocol, a fourth generation or 4G communication protocol, e.g., Long Term Evolution or LTE (from the 3^{rd} Generation Partnership Project of Sophia Antipolis, Valbonne, France), LITE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer or computer system (such as a controller) using a wired communication protocol, such as a wired communication protocol that is compatible with an IEEE 802.3 standard (which is sometimes referred to as ‘Ethernet’), e.g., an Ethernet II standard, message queuing telemetry transport (MQTT) and/or another type of wired interface. However, a wide variety of communication protocols may be used in the system, including wired and/or wireless communication. In the discussion that follows, Wi-Fi, MQTT and Ethernet are used as illustrative examples.

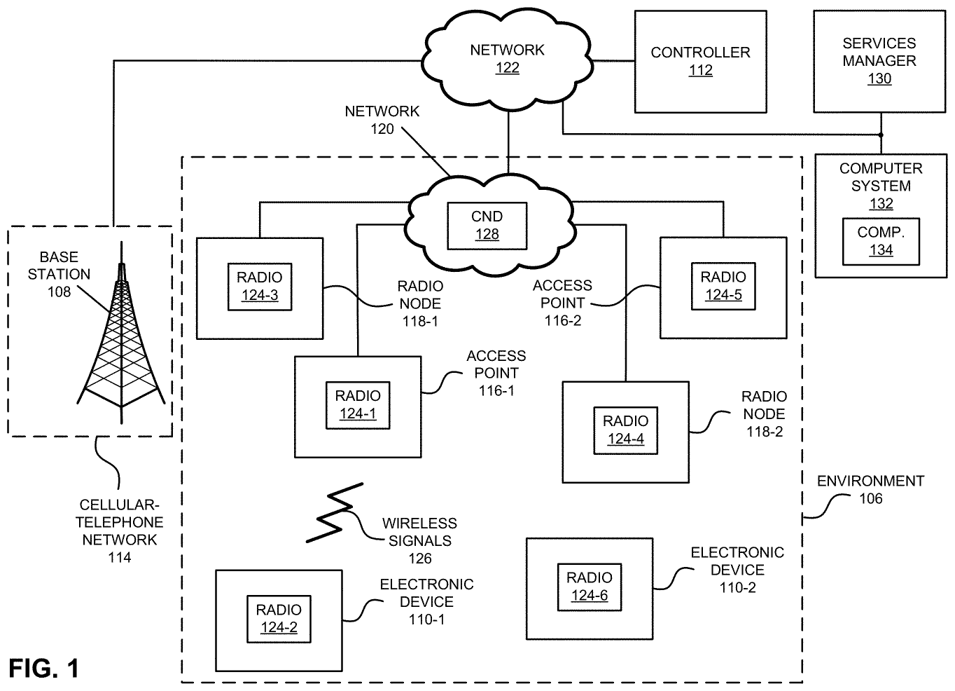

We now describe some embodiments of the communication techniques. FIG. 1 presents a block diagram illustrating an example of communication in an environment 106 with one or more electronic devices 110 (such as cellular telephones, portable electronic devices, stations or clients, another type of electronic device, etc., which are sometimes referred to as ‘end devices’) via a cellular-telephone network 114 (which may include a base station 108), one or more access points 116 (which may communicate using Wi-Fi) in a WLAN and/or one or more radio nodes 118 (which may communicate using ITE or a 5G cellular-telephone communication protocol) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other, a services manager 130, a computer system 132 and/or an optional controller 112 (which may be a local or a cloud-based controller that manages and/or configures access points 116, radio nodes 118 and/or a computer network device or CND 128, such as a switch or a router, or that provides cloud-based storage and/or analytical services) using a wired communication protocol (such as Ethernet or MQTT) via network 120 and/or 122. Moreover, computer system 132 may include one or more computers 134. However, in some embodiments, access points 116 and/or radio nodes 118 may communicate with each other and/or the controller using wireless communication (such as Wi-Fi, Bluetooth and/or another wireless communication protocols), e.g., one of access points 116 may be a mesh access point in a mesh network. Note that networks 120 and 122 may be the same or different networks. For example, networks 120 and/or 122 may an LAN, an intra-net or the internet. In some embodiments, wireless communication between at least pairs of components in FIG. 1 involves the use of dedicated connections, such as via a peer-to-peer (P2P) communication technique.

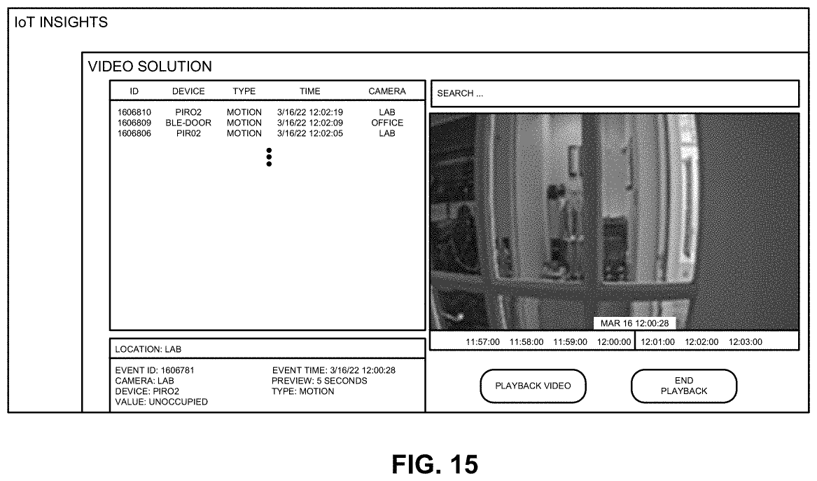

As described further below with reference to FIG. 15, electronic devices 110, controller 112, access points 116, radio nodes 118, computer network device 128, services manager 130 and computer system 132 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data or management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-squared error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple-input multiple-output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

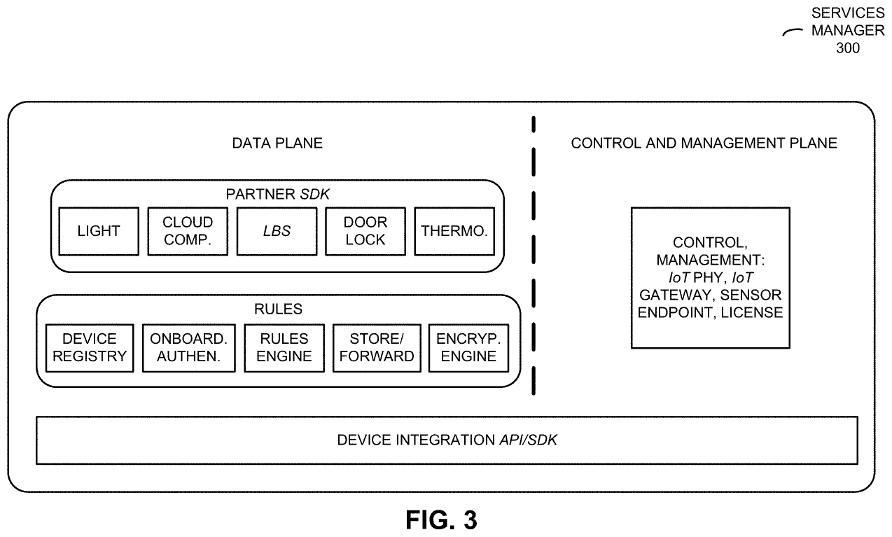

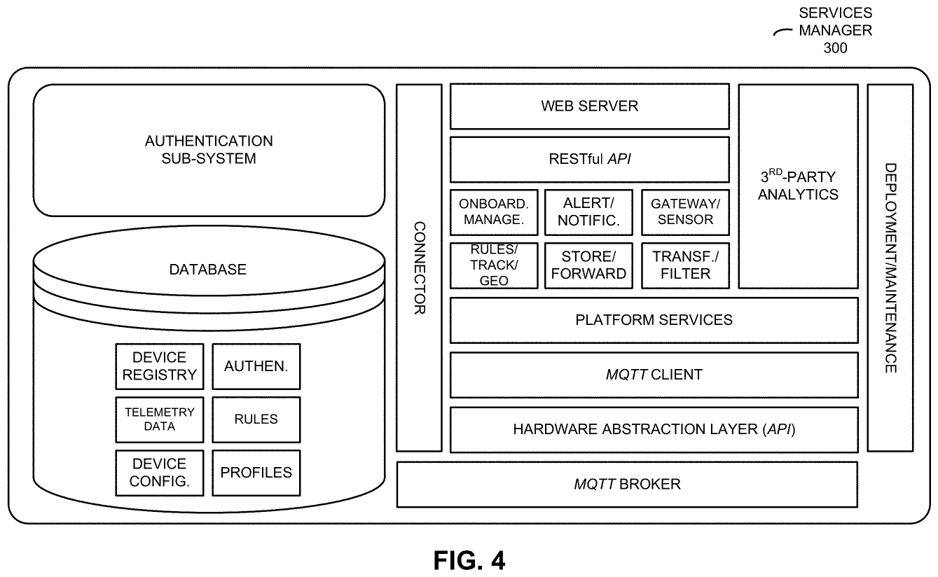

Moreover, as described further below with reference to FIGS. 3 and 4, additional infrastructure may enable at least some aspects of the communication techniques. Notably, services manager 130 may enable dynamic integrated solutions with disparate (and otherwise potentially incompatible) components, such as one or more sensors and/or actuators from different manufacturers, and/or one or more service providers. These different components may be associated with different (unrelated) entities, such as different companies or organizations.

Furthermore, services manager 130 may include: a gateway that communicates with one or more of access point 116 and/or one or more of radio nodes 118 via a communication protocol (such as MQTT); a control and management plane with system-configuration information; and a data plane with a registry of the one or more electronic devices 110, rules for the one or more electronic devices 110, and application programming interfaces (APIs) for computers (not shown) associated with service providers or computer system 132. Services manager 130 may provide a programmable, modular and integrated system for flexibly and securely exchanging data and associated services among electronic devices 110, access points 116, radio nodes 118, services manager 130 and computer system 132. Note that resources in services manager 130 that are associated with different service providers may be contained in separate environments or virtual machines. Alternatively or additionally, the resources from different service providers may be included in ‘containers,’ such as docker containers). Furthermore, the control and management plane and the data plane may be implemented in separate software stacks in services manager 130.

In some embodiments, controller 112 is used to configure settings of access points 116, radio nodes 118 and/or computer network device 128, such as transmit power, a transmit antenna pattern, a receive antenna pattern, etc. Thus, controller 112 may provide Wi-Fi control and management planes. Moreover, controller 112 may initialize IoT services that are facilitated and managed by services manager 130 and/or computer system 132, e.g., services manager 130 may provide IoT data plane and control and management plane. In addition, services manager 130 may provide a partner portal for Wi-Fi and IoT management by computers (not shown) associated with service providers or computer system 132. Note that in some embodiments, controller 112, services manager 130 and/or computer system 132 may be combined into a single device. Furthermore, note that controller 112, services manager 130 and/or computer system 132 may be local devices where electronic devices 110, access points 116 and/or radio nodes 118 are installed and used, or may be at a remote location (such as a cloud-based implementation).

In these ways, services manager 130 may provide a single-access network for Wi-Fi and IoT traffic. Access points 116, radio nodes 118 and/or services manager 130 may: manage network across different physical layers, provide sensor-to-backend management, and/or distributed decision-making (such as at the edge immediately behind a firewall versus backend processing). Moreover, access points 116, radio nodes 118 and/or services manager 130 may be: transport protocol agnostic, architecture agnostic to the transport layer, and/or may support a variety of communication or transport protocols, such as Zigbee, BLE and/or other IoT communication protocols. Furthermore, access points 116, radio nodes 118 and/or services manager 130 may: provide flexible and secure exchange of data, provide a network backbone for a variety of services, enable end-to-end services for multiple connected ecosystems, and/or provide end-to-end solutions with a simplified value chain and a single network.

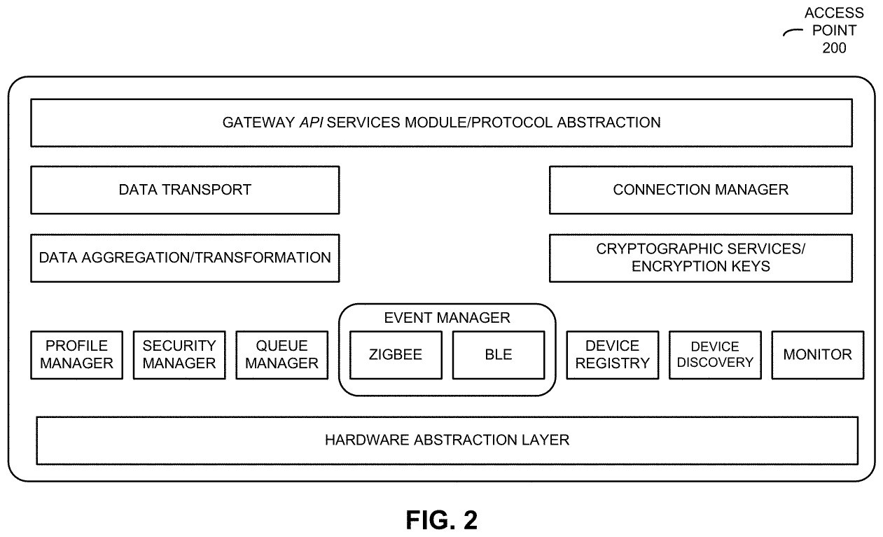

As discussed previously, it can be difficult to provide services, application and solutions using IoT data because of incompatible formats (such as formats associated different communication protocols), etc. In order to address these problems, as discussed below with reference to FIGS. 2-23, computer system 132 may implement the communication techniques. Notably, computer system 132 may obtain data associated with an electronic device (such as electronic device 110-1), which has a first format. For example, computer system 132 may include an interface circuit that communicates with electronic device 110-1, and the obtaining may include receiving the data from or associated with electronic device 110-1. Alternatively, the obtaining may include accessing the data in memory, which is included in or associated with (e.g., external to) computer system 132. In some embodiments, electronic device 110-1 is at an arbitrary location relative to computer system 132 and/or the first format includes one of a set of formats (and, more generally, has an arbitrary format). The set of formats may be associated with multiple different communication protocols.

Then, computer system 132 may compute a context of the data. Moreover, the context may include: a location of electronic device 132 (which may be specified by or may correspond to GPS or local positioning system coordinates, a port, a network identifier, a VLAN identifier, etc.) a type of the data (such as environmental data, video, sound, etc.), a type of the electronic device (such as a video camera, a temperature sensor, a humidity sensor, a microphone, etc.), the first format, and/or a gateway (such as access point 116-1 or radio node 118-1 in a network) that forwards the data from electronic device 110-1 to computer system 132.

Moreover, based at least in part on the context, computer system 132 may identify electronic device 110-1 associated with the data. Note that computer system 132 may, based at least in part on the computed context, forward the data having the first format to an appropriate resource in or associated with computer system 132 that performs the identifying (such as a particular data decoder corresponding to or associated with one or more communication protocols). Furthermore, the identifying may be based at least in part on: an identifier of electronic device 110-1 (such as a MAC address, an IMSI or telephone number, etc.), a subset of the data (such as a payload in a packet or a frame), a name of electronic device 110-1, and/or additional data associated with a second electronic device (which is different from the electronic device). For example, computer system 132 may access the additional data from another computer system, which is then used to identify electronic device 110-1.

Next, computer system 132 may translate, based at least in part on identified electronic device 110-1, the data from the first format to a second format, where the second format is common to additional data associated with multiple different types of electronic devices, and where the additional data is stored in or is associated with computer system 132. For example, based at least in part on the identified electronic device 110-1, computer system 132 may be able to decode a payload in a packet or a frame having the first format, and then may convert or translate the payload into the second format. Because the second format is common to multiple types of electronic devices, the translated data may be aggregated, stored, index, analyzed and/or used in a wide variety of applications. This may include applications that are based at least in part on data from multiple electronic devices (such as multiple different types of electronic devices) at one or more locations. Thus, the second format may be associated with multiple different applications that provide services based at least in part on the data having the second format.

In some embodiments, computer system 132 may automatically learn the first format when electronic device 110-1 and/or the data have not been previously encountered by computer system 132. For example, computer system 132 may learn the first format when a new electronic device or a new type of data is first received by computer system 132.

Note that the computing, identifying and/or translating may be performed by or using a pretrained model, such as a machine-learning model or a neural network. For example, the pretrained model may trained using a training dataset (e.g., a dataset with historical data and events) and a machine-learning technique, such as a supervised-learning technique and/or an unsupervised-learning technique (such as a clustering technique). Note that the pretrained model may include a classifier or a regression model that was trained using: a support vector machine technique, a classification and regression tree technique, logistic regression, LASSO, linear regression, a neural network technique (such as a convolutional neural network technique, an autoencoder neural network technique or another type of neural network technique) and/or another linear or nonlinear supervised-learning technique. The pretrained model may use historical data as inputs and may output: the context, the identity of electronic device 110-1 (such as the model number, the manufacturer, the location, the first format, a type of electronic device 110-1, an encryption technique used to encrypt the data, an encoding technique used to encode the data, another characteristic or attribute of electronic device 110-1, etc.) and/or the translated data.

In these ways, the communication techniques may enable the IoT applications, services and solutions. Notably, the communication techniques may eliminate the siloes between different electronic devices associated with disparate manufacturers and providers. Moreover, the communication techniques may eliminate the need for solutions based on proprietary and expensive fixed vertical integrations. Instead, the communication techniques may allow a wide variety of electronic devices (including legacy equipment) to be rapidly and/or dynamically integrated to provide flexible applications, services and solutions. Furthermore, the translation of the data to a common format may enable data aggregation, analysis and decision-making. Therefore, the communication techniques may improve the user experience when developing or creating applications, services and solutions, may enhance economic activity, may provide improved services and, thus, may enable the IoT.

While FIG. 1 illustrates computer system 132 performing the communication techniques, in other embodiments one or more of the operations in the communication techniques may be performed by services manager 130. Alternatively or additionally, in some embodiments one or more of the operations in the communication techniques may be performed remotely, e.g., by a computer or a computer system located at or near a customer premises, such as in or associated with environment 106. Thus, in general, one or more operations in the communication techniques may be implemented in a centralized or a distributed manner.

We now further describe embodiments of access points 116 (which are used as illustrations of sensor gateways) and services manager 130. Current sensor gateways often operate within closed proprietary ecosystems, which can make it difficult to integrate a wide array of management platforms and disparate sensor networks. These problems are typically compounded by architectural limitations. For example, the gateways may have monolithic non-modular architectures that often are not scalable and customizable for different sensor network deployment scenarios, and these gateways are usually tied to expensive purpose-built hardware.

In order to address these challenges, access points 116 may aggregate and disburse data across disparate sensors, and may include data-acquisition and data transformation capabilities (such as a data acquisition and transformation engine or control logic). In addition, services manager 130 may include: a gateway abstraction service, an internal software development kit (SDK) that allows management of a control and management plane, and/or a partner services SDK that allows partner services providers to manage contained resources in services manager 130 that are associated with the partner services providers. Note that communication between services manager 130 and access points 116 may use a communication protocol, such as MQTT.

FIG. 2 presents a drawing illustrating an example of functionality of an access point 200, such as access point 116-1 in FIG. 1. Access point 200 may include an embedded IoT gateway and may provide a sensor management platform that is programmable and that can be easily integrated with existing management solutions. The core gateway functions in access point 200 may include: different communication-protocol stacks, a hardware for communication-protocol abstraction (which can provide a unified view of sensors to management platform), data acquisition (such as data aggregation and transformation), prioritization (data or traffic prioritization), management (which can access and set an electronic-device configuration), security (secure electronic-device authentication, actuation and cryptographic services, such as storing one or more encryption keys associated with particular electronic devices), data transport (such as MQTT), a connection manager and/or a gateway API services module and communication-protocol abstraction. In addition, access point 200 may include: an event manager core application (for different communication protocols, such as Zigbee or BLE), a profile manager for the different communication protocols, a security manager, a queue manager, an electronic-device registry, electronic-device discovery and/or a monitor that ensures safe and appropriate operation (such as by detecting an anomaly), and that tracks communication performance, etc.

In some embodiments, access point 200 may include a trusted secure element, WLAN firmware, an IoT gateway engine or control logic (such as one or more physical layer communication protocols) and an application layer that translates between different communication protocols. Note that a given access point may provide at least one communication protocol (in addition to Wi-Fi) via a USB dongle, and groups of access points may be interleaved to provide multiple different communication protocols.

After receiving information (such as sensor data) from one or more of electronic devices 110 in FIG. 1, access point 200 may translate, into a unified or common format, the information associated with the one or more electronic devices 110, which may have been received by access point 200, at an interface circuit in access point 200, using different communication protocols. (However, as described further below, in other embodiments, the translation to a common format may be performed by services manager 130 and/or computer system 132.) Then, access point 200 may send or communicate the untranslated data or the translated information to a services manager, such as services manager 130 (FIG. 1). For example, access point 200 may provide, from an interface circuit in access point 200, the untranslated data or the translated information for one or more additional electronic devices (such as services manager 130 in FIG. 1) using another communication protocol, such as MQTT.

In some embodiments, access point 200 (or services manager 130 in FIG. 1) may provide security by selectively including communication with an electronic device (such as electronic device 110-1 in FIG. 1) in an inclusion list and/or by selectively excluding communication with another electronic devices (such as electronic device 110-2 in FIG. 1) in an exclusion list. For example, the black and/or white lists may be applied by access point 200 following a scan.

FIG. 3 presents a block diagram illustrating an example of a Virtual Internet-of-Things (VIoT) services manager 300, such as services manager 130 in FIG. 1. This services manager may include: a gateway that communicates with one or more access points 116 (FIG. 1) and/or one or more radio nodes 118 (FIG. 1) via a communication protocol (such as MQTT); a control and management plane with system-configuration information: and a data plane with a registry of the one or more of electronic devices 110 (FIG. 1), rules for the one or more of electronic devices 110, and APIs for service providers. Services manager 300 may provide a programmable, modular and integrated system for flexibly and securely exchanging data and associated services among electronic devices 110, access points 116, radio nodes 118, services manager 130 or 300, and/or computer system 132 in FIG. 1. Moreover, resources in services manager 300 that are associated with different service providers may be contained in separate virtual machines. Alternatively or additionally, the resources from different service providers may be included in ‘containers,’ such as docker containers). Note that a docker container may be a lightweight, stand-alone, executable package of a piece of software that includes everything needed to run it: code, runtime, system tools, system libraries, and settings. The containerized software may run the same, regardless of the environment. Containers also may isolate software from its surroundings, such as differences between development and staging environments, and may help reduce conflicts between different software that is running on the same infrastructure.

As noted previously, services manager 300 may include a control and management plane. The control and management plane may include: control management, an IoT physical layer, a gateway (such as a gateway engine, control logic or module), a sensor endpoint, and/or associated licenses. In addition, the control and management plane may provide system-architecture configuration, such as: transmit power, Internet Protocol or IP addresses, etc.

Moreover, services manager 300 may include a data plane with a partner SDK (for applications or services such as: a door lock, a thermostat, a light, analytical services, location-based services or LBS, cloud-based computing, etc.). Furthermore, the data plane may include rules, such as: an electronic-device registry, a rules engine or module, onboarding, authentication, an encryption engine or control logic, and store and forward.

Services manager 300 may be a dual-stack, open-programmable, virtualized sensor-management gateway platform. It may be highly customizable, deployable in multiple network topologies, and may be integrated with existing management networks. The dual-stack, open-programmable, virtualized sensor-management gateway platform may be an enterprise-grade sensor-management platform. Note that services manager 300 may be a policy-driven virtualized wireless gateway that manages a sensor network that includes one or more types of sensors from one or more manufacturers, and which may use different communication protocols. The open framework may facilitate sensor management in separate virtual machines, which may offer different vertical services. Alternatively or additionally, as described further below, services manager 300 may different types of data associated from different electronic devices 110 (FIG. 1) to be aggregated and analyzed using computer system 132 (FIG. 1), which may be associated with a provider of access points 116 (FIG. 1) and/or services manager 300. Thus, services manager 300 may be part of an integrated network solution from a common provider.

In some embodiments, access point 200 (FIG. 2) and/or services manager 300 may address a typical sensor-network management system, which may include: wireless sensor devices, a physical communication layer, a network connectivity or protocol layer, and/or a gateway layer. Notably, access point 200 (FIG. 2) may include a data acquisition layer. For example, a data acquisition engine or control logic may enable gateway communication at scale with many sensors using disparate sensor connectivity or communication protocols (such as BLE, Zigbee, Z-Wave, etc.). This data acquisition layer may include the drivers and metadata information used to recognize and communicate with the different sensor types using different communication protocols.

Moreover, access point 200 (FIG. 2) may include an aggregation and translation layer. Notably, many of the sensor connectivity or communication protocols are rudimentary and fragmented. For example, Zigbee or BILE often does not provide support for IP. The aggregation and translation layer may perform the function of normalizing the data collected across these sensors. This block may perform packet processing and encapsulation functions for disparate incoming sensor packets and the output of this block may be normalized data in a common format (such as MQTT) that is recognizable by a programmable application layer.

Furthermore, services manager 300 may include a programmable application layer. Notably, a smart-gateway abstraction service in services manager 300 may provide a full edge analysis engine or module. For example, the programmable application layer may implement blocks and functions, such as: a message broker, a rules engine or module, an onboarding engine or module, an electronic-device registry, a store and forward engine or module, and/or an encryption engine of control logic. Note that this layer may host a runtime environment and/or libraries that enable a third-party IoT SDKs, such as the partner service-provider SDKs. The routing of data packets to different third-parties may be based at least in part on predefined policies specified by a user, such as a customer or a service-provider partner.

Additionally, services manager 300 may include an open management interface layer.

Services manager 300 may be a self-contained virtual machine that includes APIs that enable a provider of services manager 300 (e.g., via computer system 132 in FIG. 1), customers and/or service-provider partners to add another layer of contextualization or customization based at least in part on specific business needs. This flexibility may make services manager 300 highly programmable and rapidly deployable.

Note that services manager 300 may be architected as a dual-stack gateway. A first stack may include the data acquisition layer and the aggregation and translation layer. As discussed previously, the first stack may physically reside in a wireless access point (such as access point 200 in FIG. 2) and/or in on-premise gateway hardware.

A second stack may include the programmable application layer and the open management interface layer. Note that the second stack may be a virtual machine that can reside on any of the wireless gateway hardware, such as access point 200 (FIG. 2), controller 124 (FIG. 1), services manager 300 and/or computer system 132 (FIG. 1). Thus, the second stack may be on-premise, in a data center or may be cloud-based. Therefore, in general functionality of access point 200 (FIG. 2) and/or services manager 300 may be implemented by an arbitrary component, such as a local or a distributed electronic device or system.

The dual-stack architecture may provide flexibility to be deployed in an arbitrary network topology. In addition, this architecture may enable a distributed gateway architecture.

The core functions of the solution (which is sometimes referred to as an ‘IoT gateway’) implemented in access point 200 (FIG. 2) and services manager 300 may include: centralized management (secure onboarding management of sensors and gateways), data aggregation (aggregate and transform data from multiple gateways), edge analytics (process data at the edge, i.e., behind the firewall, from multiple gateways), hardware abstraction (provide unified view or management of different sensor types), and/or rules and alerts (create rules and alerts, predictive analysis, etc.).

The technology and capabilities of the solution implemented in access point 200 (FIG. 2) and services manager 300 may include: self-contained container or virtual machine that can be hosted anywhere (such as a controller, a switch, in the cloud, etc.). Moreover, the solution may have multi-tenants, which provides flexible deployment models and allows the use of a public and/or a private cloud. Furthermore, the solution may have the ability to host third-party SDKs and may provide a unified view of sensors or gateways. Additionally, the solution may incorporate edge computing capabilities (e.g., via a partner SDK and/or internal capability). The solution may be highly modular with a cloud-scale architecture.

In some embodiments, an open, programmable IoT gateway module may be programmed through a multitude of management platforms using one or more interfaces. Moreover, the IoT gateway may be capable of machine learning and intelligent decision making at the edge without backhauling information to the cloud, e.g., intelligent channel selection and assignment of channels across disparate wireless radios (such as Zigbee, Bluetooth, Wi-Fi, LoRaWAN, etc.). Furthermore, the IoT gateway may automatically detect anomalies and may dynamically use rules for creation or insertion to suppress anomalies. In addition, the IoT gateway may provide notifications, intelligent tracking and geo fencing of IoT and sensor assets. Additionally, the IoT gateway may intelligently identity and classify electronic devices, e.g., learning electronic-device characteristics based at least in part on communication patterns, association patterns, and/or beaconing patterns. These characteristics may be used to assign traffic from an electronic device to a queue with an appropriate queue latency. The IoT gateway may also prioritize electronic devices and/or electronic-device categories based at least in part on the learned characteristics, which may be used to prioritization of messages and/or message categories. In some embodiments, the IoT gateway may guarantee delivery of certain IoT messages, such as based at least in part on prioritization, intelligent classification and/or machine learning

FIG. 4 presents a block diagram illustrating an example of a software architecture of services manager 300. In particular, services manager 300 may include: an MQTT broker, a hardware abstraction layer API, an MQTT client, VIoT platform services (such as Java or Python runtime platform services), a gateway or sensor onboarding management, alerts or notifications, gateway or sensor actions, a rules engine, tracking, geographic fencing, store and forward, and/or data transformation and filter. In addition, services manager 300 may include: third-party edge analytics, a RESTful API (which uses HTTP requests to GET, PUT, POST and DELETE data) for provisioning, actuation, statistics aggregation and management, a web server, an authentication sub-system, and/or a database or data structure. The third-party edge analytics may interface to external analytics services, the web server may interface to one or more external cloud-based components (such as computer system 132 in FIG. 1), partner management portals, dashboard services and/or mobile applications. Note that the database or data structure may include information, such as: an electronic-device registry, telemetry data, electronic-device configuration, authentication, rules and/or profiles (e.g., electronic-device characteristics). In some embodiments, services manager 300 supports blockchain for highly secure environments.

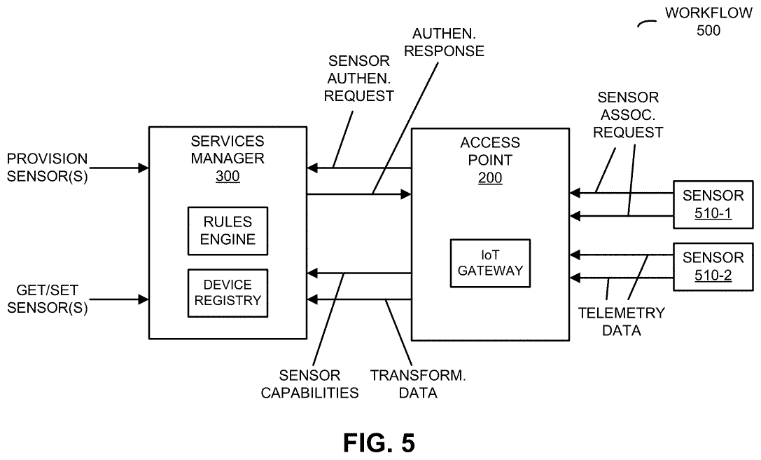

FIG. 5 presents a drawing illustrating an example of an onboarding workflow 500. Notably, sensors may be provisioned via an API call. Then, services manager 300 may create an entry in an electronic-device registry. Moreover, one or more of sensor 510 may provide a sensor associate request to a gateway in access point 200. In response, access point 200 may provide a sensor authorization request to services manager 300, and may receive an authorization response. Next, access point 200 may provide information about sensor capabilities (and, more generally, characteristics of sensors 510). Furthermore, services manager 300 may receive an API call to get or set sensors, which may be forwarded to one or more of sensors 510. In response, one or more of sensors 510 (such as sensor 510-2) may provide telemetry data. Associated transformed data may be provided by access point 200 to services manager 300. Additionally, services manager 300 may process the transformed data and/or may trigger local rules.

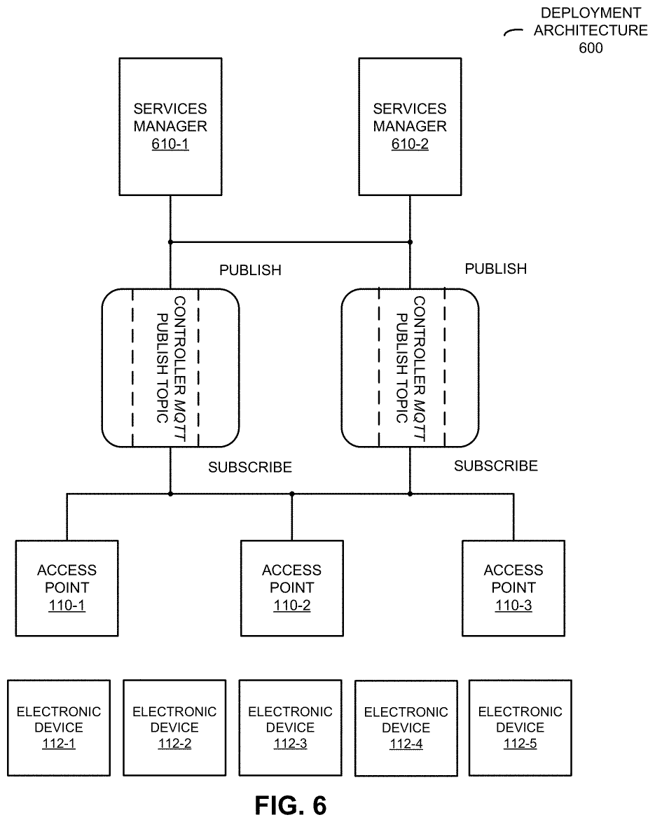

FIG. 6 presents a drawing illustrating an example of a deployment architecture 600. This architecture may include: one or more electronic devices 110 (which may include one or more sensors), one or more access points 116 (or gateways), and one or more services managers 610. Services managers 610 may publish or subscribe messages via controller MQTT publish topics. For example, services managers 610 may publish or subscribe messages using channels (which may be static or dynamic) having associated priorities.

Note that a given services manager (such as services manager 610-1) may dynamically configure subdomains in access points 116 and/or electronic devices 110 (FIG. 1) to define a range of communication using a communication protocol, such as MQTT. Alternatively or additionally, the given services manager may dynamically define channels for data traffic with electronic devices 110 and/or access points 116, where the channels are associated with different topics.

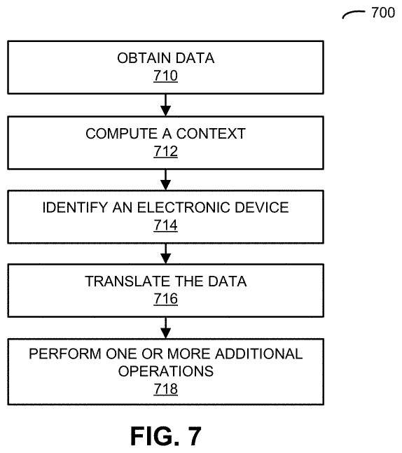

We now describe embodiments of methods associated with the communication techniques. FIG. 7 presents a flow diagram illustrating an example of a method 700 for translating data, which may be performed by computer system 132 in FIG. 1. During operation, the computer system may obtain the data (operation 710) associated with the electronic device, which has a first format. Note that the computer system may include an interface circuit that communicates with the electronic device, and the obtaining (operation 710) may include receiving the data associated with the electronic device. Alternatively, the obtaining (operation 710) may include accessing the data in the memory. In some embodiments, the electronic device is at an arbitrary location relative to the computer system and/or the first format includes one of a set of formats (and, more generally, has an arbitrary format). The set of formats may be associated with multiple different communication protocols (such as Wi-Fi, Bluetooth, etc.).

Then, the computer system may compute a context (operation 712) of the data. Note that the context may include: a location of the electronic device, a type of the data, a type of the electronic device, the first format, and/or a gateway (such as an access point or a radio node in a network) that forwards the data from the electronic device to the computer system.

Moreover, based at least in part on the context, the computer system may identify the electronic device (operation 714) associated with the data. Note that the identifying may be based at least in part on: an identifier of the electronic device (such as a MAC address, an IMSI number, etc.), a subset of the data (such as a payload in a packet or a frame), a name of the electronic device, and/or additional data associated with a second electronic device (which is different from the electronic device).

Next, the computer system may translate, based at least in part on the identified electronic device, the data (operation 716) from the first format to a second format, where the second format is common to additional data associated with multiple different types of electronic devices, and where the additional data is stored in or is associated with the computer system. This second format may be associated with multiple different applications that provide services based at least in part on the data having the second format. Note that the translating (operation 716) may include decoding the data.

In some embodiments, the computer system optionally performs one or more additional operation (operation 718). For example, the computer system may automatically learn the first format when the electronic device and/or the data have not been previously encountered by the computer system.

Note that the computing, identifying and/or translating may be performed by or using a pretrained model, such as a machine-learning model or a neural network.

In some embodiments of method 700, there may be additional or fewer operations. Furthermore, the order of the operations may be changed, and/or two or more operations may be combined into a single operation.

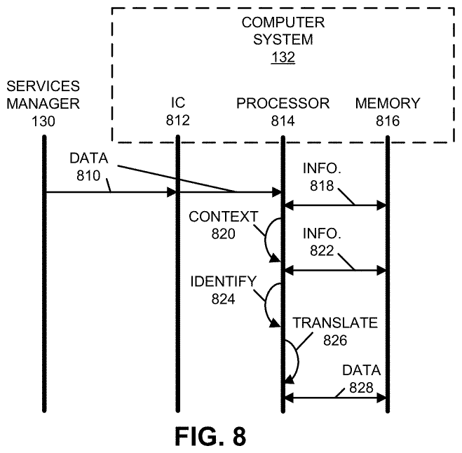

Embodiments of the communication techniques are further illustrated in FIG. 8, which presents a drawing illustrating an example of communication among services manager 130 and computer system 132. Notably, services manager 130 may provide, to computer system 132, data 810, which is associated with an electronic device (such as electronic device 110-1 in FIG. 1) and that has a first format.

After receiving data 810, an interface circuit 812 in computer system 132 may provide data 810 to a processor 814 in computer system 132. Then, processor 814 may compute a context 820 of data 810. This computing may include determining a location of electronic device 110-1 (such as based at least in part on contents of a packet or a frame that includes or included data 810, and/or using additional data from another electronic device in proximity to electronic device 110-1). Moreover, the computing may include determining (e.g., based at least in part on contents of the packet or the frame) a type of the data, a type of electronic device 110-1, the first format, and/or a gateway (such as an access point or a radio node in a network) that forwards the data from electronic device 110-1 to computer system 132 (via services manager 130). In some embodiments, the computing may be based at least in part on information 818 stored in memory 816 in computer system 132.

Moreover, based at least in part on context 820, processor 814 may identify 824 electronic device 110-1 associated with data 810. For example, context 820 may specify or indicate a resource in computer system 132 that is used to perform the identifying (such as a particular data decoder corresponding to or associated with one or more communication protocols). In some embodiments, the identifying may be based at least in part on information 822 stored in memory 816. Note that the identifying may be based at least in part on: an identifier of electronic device 110-1 (such as a MAC address, an IMSI number, etc.), a subset of the data (such as a payload in the packet or the frame), a name of electronic device 110-1, and/or additional data associated with a second electronic device (which is different from electronic device 110-1).

Next, processor 814 may translate 826, based at least in part on identified electronic device 110-1, data 810 from the first format to a second format, where the second format is common to additional data associated with multiple different types of electronic devices, and where the additional data is stored in or is associated with computer system 132. Furthermore, processor 814 may store translated data 828 in memory 816 for subsequent use by one or more applications.

While FIG. 8 illustrates communication between components using unidirectional or bidirectional communication with lines having single arrows or double arrows, in general the communication in a given operation in this figure may involve unidirectional or bidirectional communication. Moreover, while FIG. 8 illustrates operations being performed sequentially or at different times, in other embodiments at least some of these operations may, at least in part, be performed concurrently or in parallel.

We now further descript the communication techniques. In some embodiments, computer system 132 (FIG. 1) is referred to as ‘IoT Insights.’ IoT insights may be a platform for the operation, interface, conversion and/or processing of IoT sensor traffic from any IoT network or sensor interface. IoT may include a sensor, network, gateway, and application platform. A challenge in this regard is that IoT sensors tend to use a variety of IoT-specific network protocols that are not interoperable or able to co-exist on the same platform without a user or integrator performing considerable integration and transport layer conversion. Examples of this include Zigbee and Bluetooth low energy (BLE). Both of these communication protocols use a common radio-frequency spectrum at 2.4 GHz along with Wi-Fi and a range of other communication protocols, but each communication protocol uses different data and payload encoding and encapsulation. Because of this variety of communication protocols, it is typically very difficult for a user to determine which network to deploy. Moreover, this also makes it very difficult for the integration of IoT sensors into a building or environment and to ensure that a higher-layer application can decode and use this sensor protocol seamlessly.

IoT Insights takes the approach of IoT sensor networks being just a data generation tool and, as such, can receive any IoT traffic and convert it into an internally standardized protocol or common format that can be easily routed, decoded and stored for processing, analysis and/or presentation in a user interface. By using an intermediary decoder, IoT Insights may be able to connect any and all IoT sensor networks and allow them to interact without having to redesign or produce custom platforms for each technology. Moreover, IoT Insights may use an event flow-based architecture that performs a series of modular conversion and data processing functions that are able to quickly take an arbitrary IoT message from an arbitrary radio and allow it to interact with both sensor and solution platforms quickly and efficiently with little latency. These capabilities may provide a simple solution-based interface for the user. In these ways, the user may be able to focus much more on the data and its outcomes and less on the technology used to deliver the sensor data to the platform.

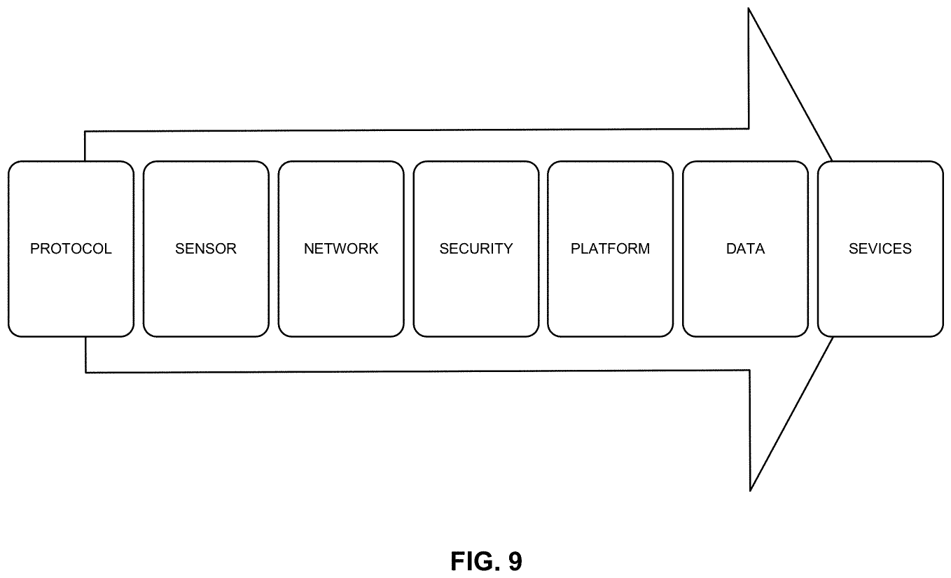

FIG. 9 presents a drawing illustrating an example of a system architecture.

By focusing on the solution and less on the IoT sensor protocol or technology, the platform is then able to provide a functionality that provides easy access to the decoded data and to any IoT sensor data through the integrated user interface and/or using one or more application programming interfaces (APIs).

Note that IoT Insights may be deployed as an on-premises solution as this provides the lowest latency with the least system-resource requirements. However, in other embodiments, IoT Insights can be deployed in a cloud-based environment under a virtual machine platform. In general, a cloud-based micro-services architecture may be used to allow for a larger scalable platform, thereby supporting more contiguous IoT controller platforms and/or for an IoT controller in the cloud.

Architecture

IoT Insights may ensure easy sensor integration, decoding and mapping. Notably, the flow-based implementation may allow for easy protocol and transport layer integration that ensures that each IoT sensor technology is easily adopted, and that the payloads from each protocol can be identified and converted without significant software effort. Next, the converted data may be easily integrated into upstream functions of the IoT Insights platform.

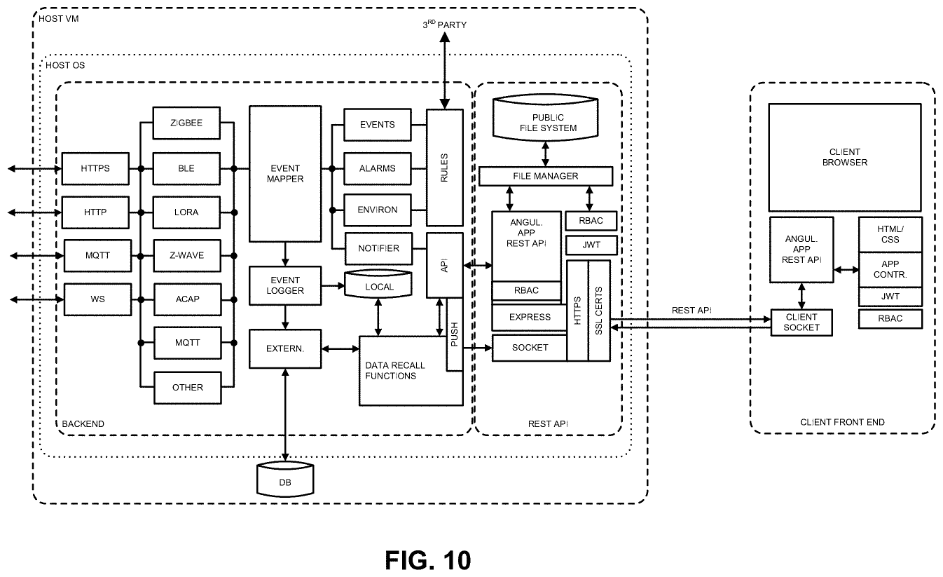

FIG. 10 presents a drawing illustrating an example of a system architecture.

Moreover, IoT Insights may receive data from external sources and gateways into a number of host interfaces. After the data is received, it may enter a flow-based event mapping series of functions that allow for a simple classification, qualification and then decoding the series of functions.

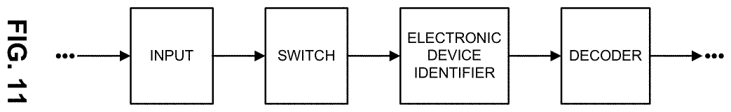

As shown in FIG. 11, which presents a flow diagram illustrating an example of a method for translating data, in order to facilitate this capability, IoT Insights may include selection of an appropriate IoT protocol decoder. The IoT protocol decoders may be implemented to be routed from an incoming interface (such as: MQTT, HTTP, web service or WS, or another interface) and then converted to a common payload or format. This common format may include the information about the electronic device associated with the data. Consequently, the IoT protocol decoder may be an initial operation in the flow for IoT Insights.

Note that the flow the input may come from a range of sockets and interfaces on the IoT Insights platform, including: HTTPS, HTTP, WS, MQTT, REST API, etc. In general, any of these interfaces can accept push events or may poll external electronic device gateways or platforms for sensor data updates, and the event or data is then routed or provided to the switch. The switch provides an internal router for the electronic-device protocol type to an electronic-device filter and decoder. For example, the switch may take an incoming MQTT push event from an IoT controller with a ZigBee electronic-device state change and may route this to the Zigbee payload decoder. After the switch forwards the payload to the electronic-device identifier, the packet may be validated as being an approved electronic device or a new (previously unseen) electronic device. Depending on the approval state of this electronic device, the payload may be processed according to its status, such as: a new unapproved electronic device; a new approved electronic device; an existing unapproved electronic device; and/or an existing approved electronic device.

Unapproved electronic devices may be stored in a local storage structure to speed onboarding and electronic-device discovery, as well as a set of electronic-device capabilities, instructions and commands. These electronic-device events may then be discarded, so that they do not proceed to the decoder. However, they may be stored in volatile storage to speed onboarding should the operator determine that they want to approve this electronic device.

Approved electronic devices may be forwarded to the decoder for payload data extraction. The decoder may be specific to the electronic-device type and protocol. Notably, each IoT protocol may use a different payload encoding technique as the format and size of the message is dependent on the speed of the technology used, the power available to transmit and the network technology used. For example, Wi-Fi-based MQTT IoT sensors may be built on higher-power, larger-speed Wi-Fi technologies. Therefore, the payload may be less restricted in size, because the speed of the network may be high and the power used may be less of a concern. Alternatively, EnOcean (from EnOcean GmbH of Oberhaching, Germany) may uses a very low-power battery-less technology, and the payload may be very small (e.g., only a few bytes), because the energy used is harvested using piezo electrical harvesting. Consequently, the power may be low and the payload may be small.

Therefore, many technologies may use a unique encoding of the data and each of these different protocols may have a corresponding different decoder in IoT Insights. Although this result in each protocol having a different decoder, the advantage is that after the data is received and decoded, the computer system can use a common internal message format that is completely independent of the IoT protocol that is used. This is where the protocol decoders may be implemented.

### Data Decoder

In some embodiments, a data decoder may be written for each IoT protocol. Thus, in order to support a given protocol and device type, a small protocol and payload decoder may be needed for each of these types and classes. By default, IoT Insights may have a range of payload decoders for a number of different IoT messaging protocols and transport layers and proprietary encoding techniques, including one or more of: Zigbee, BLE, LoRaWAN, MQuT (axis ACAP payload), MQTT (Rigado payload), MQTT (Rachio payload), MQf (Soter Technologies payload), ModBus, EnOcean, a SmartThings API (from the Samsung Group of Suwon-si, South Korea), Z-Wave, a DormaKaba Ambiance API (from dormakaba Holding AG of Ramlang, Switzerland), a Assa Abloy Visionline API (from the Assa Abloy Group of Stockholm, Sweden), etc. Each of these decoders may be able to identify, validate and/or decode payloads from each of these solutions and provide a single common output flow message that the rest of the IoT Insights system is able to interpret and at upon. The resulting output from the decoder may include a single JavaScript Object Notation (JSON) structure with the format shown in Table 1.

TABLE 1
{
device: “string with name of the electronic device,”
device_euid: “string with the electronic device MAC or European unique
identifier,”
location: “string of the electronic devices location within the realm, site,
building or floor,”
location_uuid: “Unique identfier number of the electronic device or event
location,”
type: “string with an IoT Insights identifier for the type of event returned,”
value: “string with a human-readable format and value for the electronic-
device type or state,”
payload: “machine-format hex, Boolean, string value for the state of the
electronic device,”
DBase: “destination database or data structure for this event based at least
in part on the event type”
}

The decoder may also be able to determine events (not just actions), such as open or closed from a sensor, but also network and system events, e.g., RSSI or link quality indicator (LQI) network monitoring readings or battery or power readings from the sensors. The decoders may decode these events and provide the translated data as part of the output from the decoder. In these ways, the platform may be able to handle, monitor and store IoT sensor data and events. In addition, the platform may be able to manage and monitor the overall network operation and stability for preemptive diagnostics and for electronic-device health monitoring and maintenance.

### Event Mapper

After the Payload has been converted from its proprietary format to a standard IoT Insights payload format (or the second or common format), the payload may then be passed to the event mapper. In the event mapper, the computer system may determine the route for the payload to take (such as the optimal route) or if it should be sent to multiple locations at the same time. An event payload may be classified and then routed based at least in part on this classification. Note that the event may be one of the following types of classifications: an IoT event, an environmental event (such as an environmental condition), an alarm event (such as an open door), a network event, or another type of event.

How the data is routed and the parsed may depend on the classification. Notably, IoT events may be forwarded to the IoT event logger function, while environmental events may be handled by an environmental logger. Moreover, network events may be saved in different locations. The events may be handled differently as they may require additional data for processing and saving. For example, a door contact sensor may require video playback to be associated with the event so that the operator can recall the exact moment a door was opened, while this is not required for network or environmental events. In addition to the routing, the event mapper may also provide the basic functionality that allows for trigger detection and system-level alarm notification. The trigger monitoring may enable system-level monitoring of event types against a system-wide threshold alarm level and then notifying when any electronic device or location exceeds one of these levels.

The event mapper may consider all events based at least in part on the type, and may compare these events to the system-trigger thresholds, which may be configured by an operator. When one of these thresholds is exceed, the event mapper may trigger a system-wide notification and alarm. In this state, the event mapper may notify a user interface and API that this electronic device and location has triggered an alarm and show this on the user interface and/or API. Moreover, the event alarms integrated into the event mapper may reduce the computer-system overhead and may provide a notification in the event of a threshold being exceeded, as opposed to relying on an external or an extra service to independently detect this trigger.

### Event Logger

After the event has been mapped, the payload may be forwarded to the event logger. This function may format and save the data into a database or data structure. The database or data structure may provide separate tables for different event classes and as such may also support multiple asynchronous read, write and/or queries to provide for a large-scale deployment in which multiple operators and thousands of sensors are interacting (e.g., concurrently) with the database or data structure. The event logger may also ensure that events are logged correctly into the database or data structure with additional data (such as additional data that is stored, and thus associated with, an IoT event, e.g., additional data associated with a proximate or nearby electronic device, so that the additional data can be aggregated with the IoT event data and analyzed as a set). This additional data may include location-specific information so the platform is able to search and filter based at least in part on the electronic device and location during development and data recall. In addition to the location data, IoT Insights may have the ability to interact with third-party video management systems, and may identify if an electronic device is in a location where there is a camera. If yes, the electronic device may synchronize the video server time to the local system time to ensure, when video playback is required, an exact time stamp is available to recall the video to the event time.

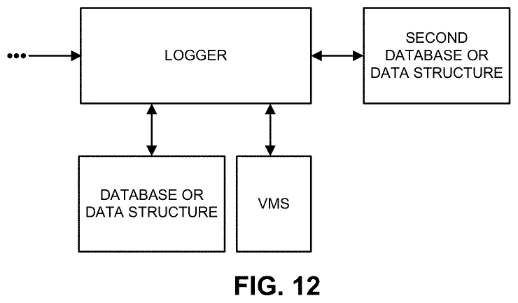

FIG. 12 presents a drawing illustrating an example of an event logger. Notably, the payload arrives with the electronic-device name and type. The logger may query a database or data structure for the location of the electronic device. Then, its location identifier may be validated against the video-camera list to see if a camera exists at the electronic-device location. If there is a camera, then the video management software (VMS) may be queried for a VMS timestamp that matches the current system time of the received event. After the VMS timestamp, the VMS epoch and the location identifier and camera data are returned, the event may be logged into a second database or data structure with the validated information for this event. The advantage of this approach is that the API recall function that returns this event may have 100% of the information needed to reconstruct the event and to interface with the VMS to recall the exact video camera and timestamp of the event from the VMS, and may replay a video of the event without exercising multiple API requests or multiple API calls with the VMS. The returned data may include the accurate data to view the video that is based at least in part on the system time of the VMS (instead of the host operating system). This may allow multiple video interfaces, e.g., around the world in different time zones, to be synchronized and accurate without worrying about time drift or changes in the time zones.

### Rules Engine

In addition to the event logger, the Event may be sent from the event mapper to the rules engine. The rules engine may use an if-this-then-that (IFTTT) approach, but may provide a scalable single-in multiple-out approach to this IFTTT with the addition of time-configurable rule sets. This may allow an operator to develop customized rules that can be triggered from a single input event and to send multiple output events with either conditional time constraints or with delayed responses.

The rules engine may be able to act on an incoming IoT event or environmental event and then trigger one or multiple output rules based at least in part on this incoming action or data. The outputs may include one or more of: an IoT electronic-device control, a REST API call, an SMS or text notification, an e-mail notification, a MQTT event, etc. Each of these outputs may be configured separately and combined together to send one or multiple actions based at least in part on a single input. Additionally, the rule may be configured so that the output can be limited to particular days of the week or time of the day when they are acted on. For example, if the door opens Monday-Friday between 8 pm and 6 am, turn on the lights. Otherwise, do not turn on the lights. This time and/or day action may allow for complicated rule generation that can be used to better tune the operation of an environment or to act differently based at least in part on the day of the week and/or time of day.

In addition to the time and/or day filter, an additional delay option may be available that allows the output to be delayed by a defined period of time. For example, this can be used to turn a light on then off after a defined period, such as when motion is detected, then turn on the light between 8 pm-7 am, and then turn the lights off after 60 s. This may allow for the computer system to detect someone entering the lobby in the evening, and then to automatically turn the lights on and then off again when they leave. In addition to time delays, the computer system may also detect when there is no activity, e.g., the occupancy or a room is clear or the door closed again, so that the lights can turn off after 60 s to ensure that the area is clear.

By using the rules engine in these ways, the computer system may optimize the environment and use it to tie into wider solutions for applications, such as: occupancy monitoring and use; energy management thorough occupancy detection; automatic notification; smart apartments; efficient hotel rooms; staff safety; safer schools through classroom monitoring; vape and bullying detection and notification; tripline detection (such as a wrong-way notification or indication); left-item alarms; and/or another type of application.

### Roll-Based Access Control (RBAC)

RBAC is a system and process that IoT insights may use to provide different levels of access to the computer system and its data. RBAC is an industry technique that allows for a user to be assigned with a specific level of access to information. Moreover, in IoT Insights, there may be three levels of RBAC: operator, supervisor and administrator. Each of these levels may have additional levels of access to the user-interface configuration and data based at least in part on their level. In addition, there may be an administrator roll with the administrator user that has an additional level to configure mission and system critical settings, such as marketplace and network interfaces, or to be tablet to configure advanced services or cloud services. Note that the three roles and the super user may be managed through the API interface in IoT Insights.

### Back-End Device Site Screening (BEDSS)

BEDSS is a function that IoT insights may use with the RBAC to limit user access to data, and to electronic devices that are assigned to their list. Notably, BEDSS may be a list that is assigned to each user. This list may include the sites that the user can operate within. For example, while there may be ten sites around the world, using BEDSS these may be arranged in a hierarchy, so that each local operator, supervisor or administrator may only manage their own site, while an operator, supervisor or administrator with appropriate privileges may manage two or more sites. BEDSS may allow the computer system to limit each user to only view, operate and/or manage their own site by specifying their site in the BEDSS list of that user. In this way, any API or user interface calls they make to the computer system may be restricted to their matching site list and the requests may be accordingly filter. Note that the BEDSS list may enable the system administrator to add, modify and/or delete the BEDSS list entries for each user, such as by adding or removing access rights to a site quickly and easily use the API and/or user interface. If a user tries to read or write to an event, electronic device, and/or location that is not in their BEDSS list, then the computer system may block this request and flag this in the log for the attention of the administrator.

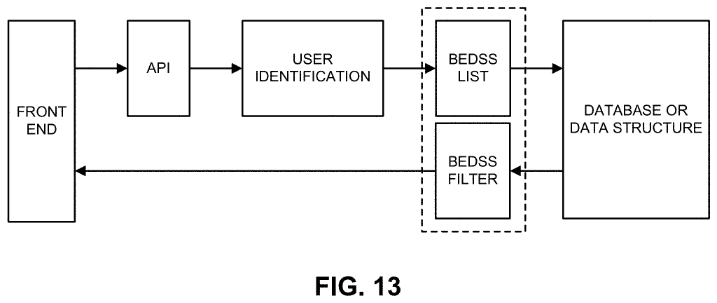

FIG. 13 presents a drawing illustrating an example of BEDSS.

BEDSS may also provide the functionality of a multi-tenant system without the overhead of a microservices platform and in a much smaller floorspace for the platform and code. This is because the computer system may manage BEDSS activity at a fundamental API level through data filtering and event removal.

### API

IoT Insights primary interface may use a REST API. This API may provide access to the backend through API calls that are controlled through a JSON web token (JWT) authentication and authorization technique that is tied to the user account and credentials. Moreover, the JWT authentication and authorization technique may be used to identify and restrict access to the computer system via the JWT credentials. The user authenticates with the computer system through the API or ITP authorization technique may use basic authorization, but after the user is connected to the computer system, they may be issued with a JWT that has a, e.g., 24-hour life. Subsequent actions and requests may be signed using this token, because basic authorization may not be allowed or permitted for any API calls except login.

The JWT technique may be tied to the user account and access RBAC level. Consequently, it may be tied to the BEDSS system for data access, thereby ensuring that the user can only access the API functions associated with this account and their BEDSS list of approved sites. The API may provide access to the core capabilities of the backend interface. Moreover, the API interface may not provide access to the data layers or IoT interfaces used by sensors or other IoT transport layers, and may only be used for the API management and data access parts of the computer system. The API may be fully expandable to provide the operator or a third-party integrator the ability to develop their own application using the data or events from the IoT Insights platform without the need to use the provided API for the user interface.

### Event Recall

In addition to the user interface (or dashboard) and applications, the computer system may provide a series of API event recall functions that allow direct access to historical data for analysis reporting or illustration within a user application. This may ensure that the data access is easily available to the user, integrator or operator without complicated filtering. The API and data recall may include the data needed to understand and visualize events in a common format for graphs, video playback or reporting without the need to understand the underlying IoT protocol or technology. For example, the ability to search for environmental data at specific locations between dates or ranges and then quickly illustrate and visualize the data and identify its type without understanding the sensor type that generated the event is a major advantage. Notably, if a series of LoRaWAN, Z-Wave, Zigbee and/or BLE electronic devices are deployed in one location, the user would need to decode four different payloads to extract the data, which could be in different standards or scales depending on the protocol. IoT Insights baselines this data to a common format and timestamp or reference allows the API call to recall the data that is already standardized and ready to filter, sort and display on an arbitrary user interface or reporting platform or that can be built or illustrated in the provided solutions platforms.

### IoT Insights Solutions

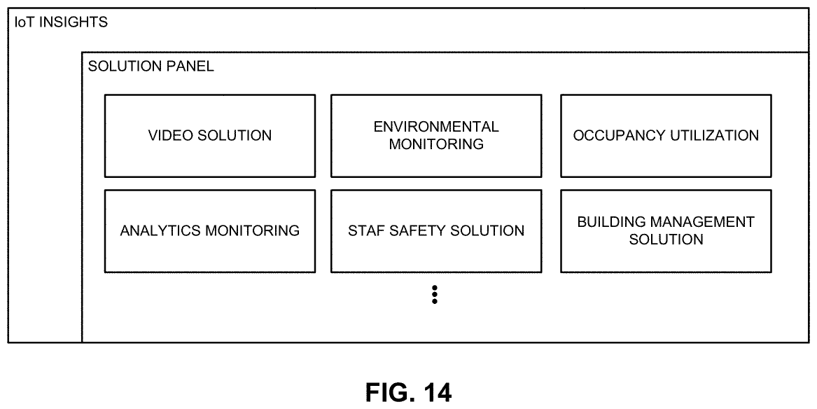

In addition to the functionality for IoT Insights to support an arbitrary IoT protocol or standard messaging format, IoT Insights may provide the event storage and recall capability needed for solution development and optimization. IoT Insights solutions may be additional application layers that are accessed through the IoT Insights marketplace that allow for the addition and installation of custom data monitoring and management applications that sit on the IoT Insights platform. Solutions may provide access to live events for reporting and notification with customized rules monitoring and generation along with customized and target optimized application user interfaces or dashboards. Because solutions are custom applications that meet specific market needs, there may not be a limit to the type or range of application solutions that can be developed. FIG. 14 presents a drawing illustrating an example of a user interface indicating installed solutions in an IoT Insights solutions panel. These solutions may access and leverage at least some of the same data. In the discussion that follows, four solutions are provided as illustrative examples.

### IoT Video Solution

The video solution may be an application solution that provides event video recall monitoring and access. In environments such as schools, hospitals or assisted-living environments, there are often situations where location monitoring is required, such that an event needs to trigger an alarm that could require immediate action. In these cases, a delay in responding may result in the loss of data, information equipment or people. In these situations, the ability to quickly recall the event and identify what happened and who was involved may be crucial. However, video management systems often do not provide instant access to the video feed, even if the operator is skilled and knows the approximate time of the event. Notably, the location and specific camera may not be known, and the time needed to find the time, location and camera can make a large difference in the success of recovery.

In the Video Solution for IoT Insights, there may be a direct interaction between the IoT Insights IoT monitored event, the physical location of the electronic device and its associated video camera. Additionally, the virtual machines and IoT Insights may be synchronized at a time level to ensure that any clock skew between disconnected systems is mitigated and that every event logged is exactly synchronized with the camera and time of the VMS system clock, thereby ensuring that event recall is rapid or instantaneous.

### School Use Case

In schools, there is an epidemic of vaping. Notably, in the last few years, there has been a significant increase in incidents of students vaping in bathrooms. Indeed, vaping is reaching such a level that schools are either closing access to bathrooms because they cannot staff multiple bathrooms, or they are removing bathroom doors to reduce the number of incidents or increase the probability of catching students in the act of vaping on school premises. While there is technology that can detect the presence of vaping in bathrooms and that can send notifications via text or SMS to staff, the probability of the staff catching or identifying the student(s) in question is very low and as a result the opportunity to educate and inform them of the dangers is missed. Some schools have installed video cameras outside of bathrooms to try to mitigate the problem. However, the ability to identify the students and co-ordinate the search for incidents across multiple cameras is often ineffective. Multiply this by the number of bathrooms and incidents per day and it is clear that this problem remains unsolved.

IoT Insights takes the integration and management of this solution into a common platform by tying the vape sensor and video camera together in a common platform and event mapper, which provides the output on a single user interface or dashboard. When an event is triggered (such as vaping is detected) the computer system may log the time and location of the event along with the local camera outside the bathroom and the VMS time stamp. This event is then stored in the event log and flagged as a vape event for later review by a member of staff. Additionally, a notice can be sent to the staff of the location and information specifying the type of event if they are nearby. After the staff member logs into IoT Insights, they can see outstanding events and open each one in turn (such as activating a first user-interface icon to start the IoT video solution, activating a second user-interface icon to select a given event, and activating a third user-interface icon to play the associated video). These action(s) may recall the video at exactly the point of the vape or reported event, or a predefined time interval before the event. The staff member can then identify the students entering the bathroom before the event and see who leaves after to then schedule a discussion with that student(s) and take appropriate action.

This integrated solution may eliminate the need for searching through hours of video and the difficulty in identifying the correct camera. Instead, each event may be exactly queued up with the correct video time and event for the staff to view and act on. Note that this integrated approach to IoT event and video may be used for an arbitrary IoT event and can be logged or filtered as needed for either a specific application or a more generic event video association.

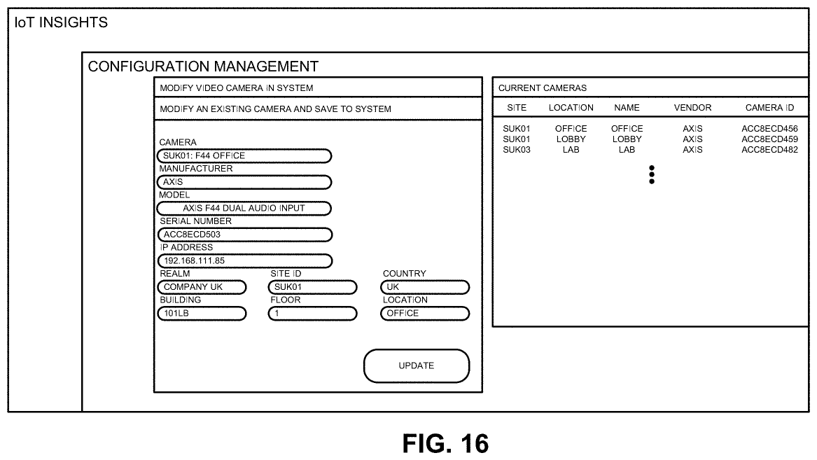

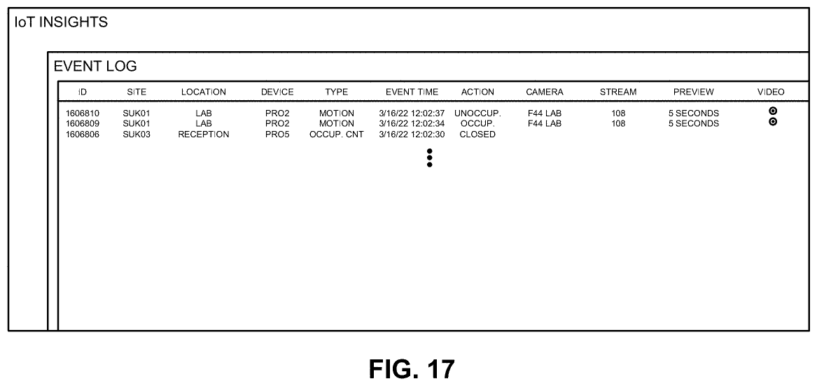

FIG. 15 presents a drawing illustrating an example of a user interface with video and IoT event synchronization. Moreover, FIG. 16 presents a drawing illustrating an example of a user interface with camera-to-location mapping. FIG. 17 presents a drawing illustrating an example of a user interface or an IoT event log with video data indication.

While the preceding discussion illustrated the IoT video solution with vaping, more generally, the IoT video solution may be used with a wide variety of types of events, such as: a violent incident (such as a shooting), theft or another criminal act, bullying, fire, a medical emergency, an accident, activation of a motion sensor, etc. Moreover, the IoT video solution may tie video from one or more cameras or imaging sensors to a wide variety of sensor(s) as inputs, including one or more of: motion, heat, audio, acoustic, vaping, an environmental sensor, a contact sensor, and/or another type of sensor. This capability may assist in managing events and, as needed, collecting evidence to document what occurred and who was associated with a particular event. Note that in some embodiments the video may be stored by a third party that is separate from or different from a provider of the computer system or the IoT video solution. When needed, the IoT video solution may link to this externally stored data, e.g., by using a pointer to a memory location. This capability may help ensure privacy of individuals and regulatory compliance, such as with General Data Protection Regulation (GDPR).

### Building Management Solution

When looking at IoT sensor data, there is typically a focus on environmental and energy management and monitoring platforms. Currently, several third parties are developing monitoring and sensor technologies that measure temperature, humidity, CO₂, volatile organic compounds, illumination, pressure and/or energy use. Although these sensors provide useful data, the measured values are usually not useful unless: they are acted on, and/or can be analyzed to provide trends and predictive analysis or a conclusion on the interaction of these values and sensors. In buildings, the concentration of sensors in a location can provide a lot of data. However, confusion about what is actually going on in the environment may result. The IoT Insights building management solution platform may enable the ingestion of IoT environmental and energy monitoring sensor data (such as lights, locks, utilities, environmental conditioning systems, network services, etc.). Moreover, the IoT insights building management solution platform may then provide analysis and predictions of future data for trend analysis, predictive machine-learning or weighted decision-making techniques that provide analysis and conclusions about locations or buildings based at least in part on the data.

### Hotel Use Case

Currently, hospitality use is fluctuating from 100% to low single digit occupancy based at least in part on seasonal trends and external factors. These wide-ranging swings in occupancy have a huge impact on the operational efficiencies of large hotel chains and small boutique hotels. Because rooms can go unoccupied for months at a time, it is no longer efficient to just leave the air conditioning on 24/7 and just reduce the setting. Notably, as the price of energy continues to rise, this approach becomes prohibitively expensive in order to maintain the environment. Alternatively, just turning off the air conditioning is also often not an option, because the increase in humidity can result in increased organic compound growth (such as mold) and can result in a dangerous environment for staff and guests.

The introduction of a smart building management system that is able to monitor a range of environmental factors in each room or location ensures that the computer system is able to proactively monitor and manage each location to keep the temperature, humidity and volatile organic compound levels in the air with a suitable safe range, thereby maintaining the air quality, while at the same time minimizing the energy used. The computer system may be able to proactively turn on the air conditioning when the temperature and humidity reach unsafe levels or environment levels conducive to volatile organic chemical growth, and additionally to modify the environment by selectively opening or closing the shades, blinds and/or windows to circulate the air or to reduce the direct sunlight that would rapidly increase the temperature of the room without activating the air conditioning.

Furthermore, the IoT Insights building management solution may allow the operator to monitor and filter the location data and to clearly identify the current situation, trend and any alarms or values that have been reached that could be considered as a warning. Because IoT Insights monitors and logs the data for multiple (or even all) electronic devices and identifies the electronic-device location, this solution may be able to filter the data to identify the most-suitable data for analysis before displaying this on the user interface. Additionally, the IoT insights building manager may predict the trend and project output or measurement forward in time using a range of predictive trend analytics formulas (or pretrained predictive modes, such as a machine-learning model or a neural network) and provide an indication of these trends, along with an indication of any historical highs or lows for each reading type. These predictions or projects may be used to indicate potential problems that could need addressing.

In some embodiments, the analytics capabilities may be expanded with external weather forecasting integration and analysis to include forecast temperature, humidity and rain along with third-party air quality monitoring services that can be used to more efficiently determine if this will affect the local prediction or will proactively require more proactive mitigation techniques to ensure the location stays within specified environmental conditions.

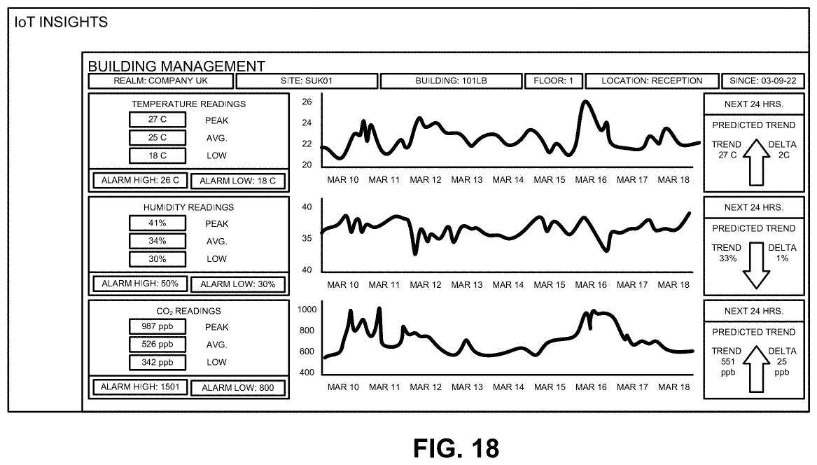

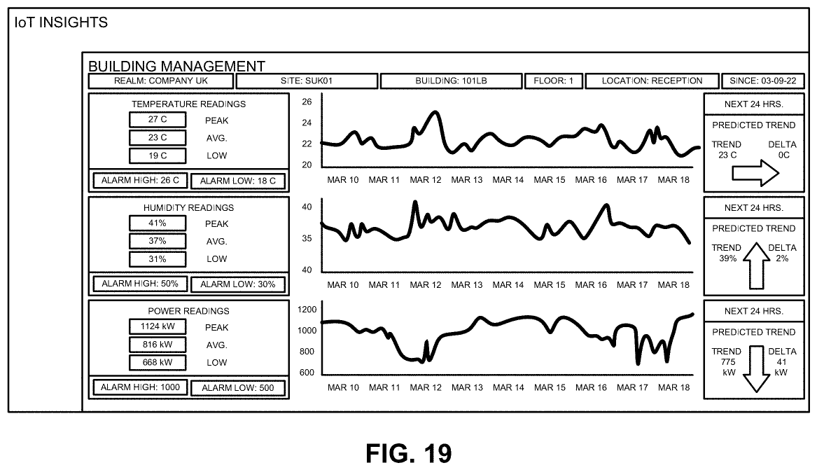

FIG. 18 presents a drawing illustrating an example of a user interface with temperature, humidity and CO₂, associated with an IoT Insights building manager solution. Moreover, FIG. 19 presents a drawing illustrating an example of a user interface with temperature, humidity and power associated with an IoT Insights building manager solution.

### Occupancy Utilization Solution

As real-estate prices continue to rise and the cost of providing energy and services to real-estate increases, more companies and organizations are looking at the spaces they have and how they are being used rather than looking to increase their space requirements. If a space is not being used efficiently, then it may be more cost effective to redesign or re-allocate the existing space than to add more floor area. This analysis is often more difficult than expected because it involves trying to understand fundamentally nonlinear organisms (humans) over time and to see how they move about a space. Add to this the resistance to tracking or monitoring people directly through tagging or cameras, and the analysis often becomes even more difficult and challenging for building owners and/or operators.

Moreover, the IoT Insights occupancy utilization solution may provide a non-intrusive and sensor-agnostic platform that addresses these issues. Notably, this solution may use a range of IoT motion or occupancy sensors that can be combined though a series of techniques and data analysis functions to determine the space utilization within a building. While there are many dedicated solutions that can count people of monitor people in a building or track them throughout spaces, these approaches tend to require hard-wired sensors that are expensive and require cable infrastructure, or they generate large amounts of personal data that needs to be filtered and obfuscated before being analyzed. Furthermore, the existing approaches typically do not provide the accuracy levels required to indicate which room or location a person entered without an incremental overhead network or expensive technology additions to the deployed network (such as radio frequency identification or BLE angle-of-arrival and/or angle-of-departure, which usually require expensive gateway or sensor designs).

Additionally, while there are many motion and occupancy sensor electronic devices available in the IoT Space, these sensors often use infra-red to monitor a space and detect movement and/or the presence of a user or human within a space or viewing angle. These sensors then detect that an infra-red source has moved and/or is present. Consequently, these motion and occupancy sensors are typically easily available, very cost effective and easy to integrate into the IoT Insights solution.

### Enterprise Utilization Example

In an enterprise application, the ability to monitor the building utilization has recently become more of a focused activity. Typically, companies need to know how many people are using the building, which parts of the building are used the most and where staff are congregating. This analysis needs to occur without adding significant additional technology or tracking the cellular telephones of individual staff members. IoT Insights occupancy utilization solution takes inputs from an arbitrary IoT motion or occupancy sensor, and filters (to remove unnecessary or un-useful data) and analyzes the data through functions to provide a common user interface or dashboard of utilization statistics based at least in part on the location or electronic device that the building manager can easily understand and process. Moreover, the solution uses the IoT Insights API and data recall functions to identify the location of interest, recall the data and/or analyze or graph this for illustration. IoT Insights Functions may clearly and efficiently preprocess the data to identify invalid datapoints. Then, using optimization techniques, the data may be condensed into an illustration of the space utilization over time. Furthermore, the solution may be able to illustrate the total utilization of the space on any given day, week or combination so that the building owner is able to better manage the space and building resources.

Note that the solution may provide the operator with a clear and concise series of datapoints that will inform them of the space usage and that may also assist in the development of future use-case optimizations. For example, the optimization may include hot desking re-assignment of space to more utilized functions, and/or building-space rationalization or reduction.

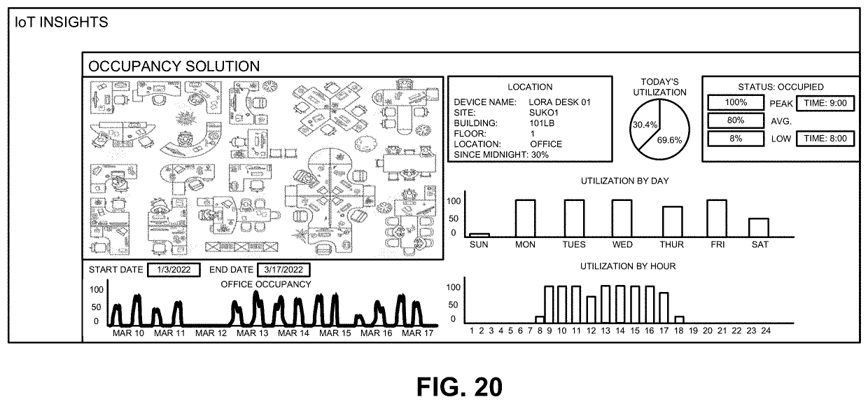

FIG. 20 presents a drawing illustrating an example of a user interface of an occupancy solution. This user interface provides data on the floorplan and current location status, and illustrates the occupancy utilization for the past week and 24 hours with an ability to custom search for events at this location and to graph them to see trends, areas or times when the space is over or under occupied.

In some embodiments, the IoT Insights occupancy utilization solution may include a wider ability to search based at least in part on multiple sensors in a location to show more granularity on the occupancy, along with the ability to include people counting sensors that can monitor the number of people entering and leaving an area. This data may be combined to show not just utilization, but also to provide a graph of people, integrating the total number of people that used a space over time and identifying any areas that are seeing a much larger footfall. Moreover, the IoT Insights occupancy utilization solution may provide recommendations on optimizations and potential routing or efficiency savings (such as when to clean office space or restrooms, better or optimal ways to use conference rooms or office space, etc.).

Staff Safety Solution

Staff safety is a common problem for many organizations around the world. Currently, there are a number of professions and workers who are exposed to potential danger just through their chosen profession. These staff members are looking to their employers and technology to provide safety measures to protect them, but at the same are worried about the inclusion of technology that reduces their rights, privacy or wellbeing.

There are many use cases worldwide where a staff-safety requirement is being mandated at either a company or government level. For example, local laws now require individual staff to be protected in certain conditions from assault, attack, intimidation or abuse. These regional requirements are forcing the building, company or operator to provide front-facing staff with the ability to provide notification of an attack or to flag an assistance-required alarm while still maintaining the ability to be mobile and identify their position. Some third parties are using cellular telephone technology to achieve this, e.g., via GPS tracking or BLE tags that identify the location to a cellular telephone. However, these approaches typically require a staff member to have, use and/or carry a cellular telephone, which may not be ideal or even allowed in some jobs, regions and locations. In addition, it often requires that the staff member can reach the cellular telephone to flag the alarm. A more user-friendly, lower-cost and simple-to-use solution is desirable, while also providing assurance that the staff location and movement is only being monitored at all times (only when an alarm is triggered).

### Hospitality Panic Button Example

There is now a US requirement that all hospitality front-customer-facing staff be provided with staff-alert monitoring tags. These tags may require that the staff member is able to send an alarm from a untethered electronic device that indicates the staff member's location at the room level, as well as the time and user name so that assistance can be sent and targeted to their location. As discussed previously, in this situation staff are often not permitted to carry cellular telephones. Moreover, a cellular telephone may not be a suitable notification electronic device because of the complexity of sending the alarm.

In order to meet the regulatory requirements, the computer system may need to detect the presence of the staff member at the room level. Then, the computer system may need to determine if they pressed a panic or assistance alarm, and also then to detect if they subsequently move from this location. On the backend, the computer system needs to flag this alarm and notification and user identifier to a user interface. Moreover, the computer system may use a notice system for SMS or text and/or e-mail and application-based notification. Furthermore, the computer system may provide regular updates about the location to responding staff or security. To these ends, a platform that uses BLE tags that only transmit when pulled or triggered may a good solution with sufficient battery life, accuracy and privacy to the staff. Additionally, gateways in each location may be used to detect the presence of these electronic devices. Notably, the solution may use calibrated location gateways to determine the nearest or best location for the tag and may relay this to the backend via the network. Next, the solution may determine the Location, interact with video for evidence capture and event recall, along with the ability to continually monitor updates on the situation as the tag moves. The backend may continue to provide updates on the current location and desired directions for security staff enroute to the incident.

In some embodiments, the computer system may provide event notifications and alarms for the incident by SMS or text, e-mail and/or REST API push notices to external speakers or alarm electronic devices. Furthermore, in some embodiments, the solution may integrate a variety of types of data, including one or more of: audio (e.g., of glass breaking), a panic button, a radio, etc. Additionally, in some embodiments, when there is a security or safety incident or event, a secure wireless link or portal for remote access to a security map in an operations center may be provided to a remote electronic device, such as an electronic device associated with law enforcement, fire, ambulance, and/or another type of first responder or emergency services.

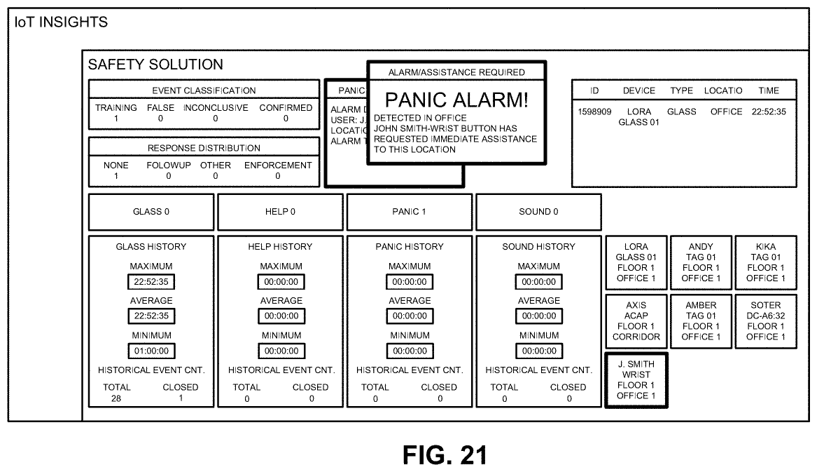

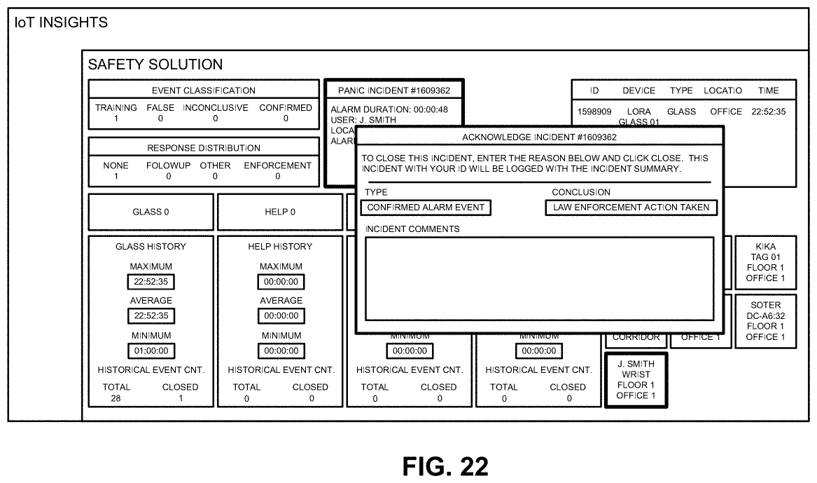

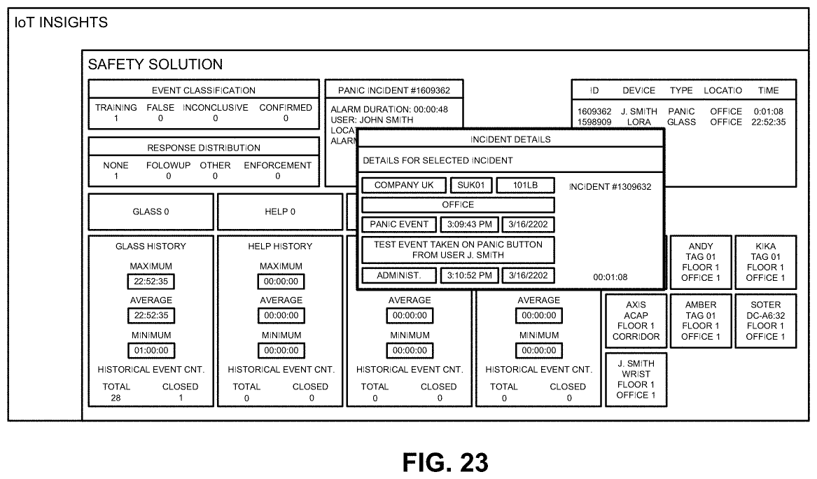

FIG. 21 presents a drawing illustrating an example of a user interface of a staff-safety alarm panel with a panic event notice. Moreover, FIG. 22 presents a drawing illustrating an example of a user interface of event closure with comment and classification options. Note that a staff-safety event cannot just be closed. Instead, a user with appropriate privileges may need to login and provide a reason that the staff-safety event was closed. FIG. 23 presents a drawing illustrating an example of a user interface with event recall and an overview of data or classification.

### Additional Application Solutions

The disclosed framework may allow multiple advanced solutions to be developed, implemented and supported based at least in part on this common data approach. Thus, as new technologies are added, they can quickly and seamlessly integrated into application solutions without re-writing the entire platform or continually modifying the core framework. Examples of additional solutions include: asset tracking of electronic devices or tags in a building; geofencing detection of an electronic device leaving a secure or identified area (such as triggering an event when a laptop with a tag is taken outside); location blocking and/or detection of an electronic device entering an unauthorized area; water temperature and/or quality monitoring (such as Legionella protection); water monitoring (such as a flood and/or basement monitoring system); a multiple dwelling unit (MDU) apartment manager (such as a property owner's provision and configuration of tenants); energy management (such as automatic power control based at least in part on load and/or pricing); an MDU room manager (such as a student accommodation heating manger based at least in part on occupancy); fire door monitoring (which may sound an alarm and respond to a fire door being propped open); assisted-living fall detection (which may sound an alarm if an elderly person or a resident falls or fails to return to bed with a predefined time interval); a dementia patient monitor (which may automatically lock doors when a patient approaches); school bullying or disturbance alarm and video recall; and/or violence or gunshot detection and alarm generation. These and other applications may leverage or use the same core data. These applications may be installed and may run concurrently with the computer system acting on the same data and functions with the intent to provide flexible and versatile solution(s) to analyze, predict and interact with arbitrary IoT sensor data.

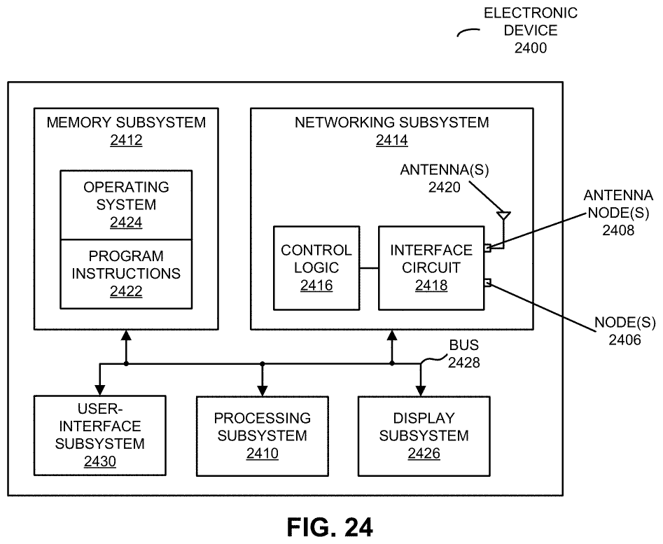

We now describe embodiments of an electronic device, which may perform at least some of the operations in the communication techniques. FIG. 24 presents a block diagram illustrating an electronic device 2400 in accordance with some embodiments, such as one of: base station 108, one of electronic devices 110, controller 112, one of access points 116, one of radio nodes 118, computer network device 128, services manager 130, computer system 132 or one of computers 134. This electronic device includes processing subsystem 2410, memory subsystem 2412, and networking subsystem 2414. Processing subsystem 2410 includes one or more devices configured to perform computational operations. For example, processing subsystem 2410 can include one or more microprocessors, graphics processing units (GPUs), ASICs, microcontrollers, programmable-logic devices, and/or one or more digital signal processors (DSPs). In some embodiments, one or more components in processing subsystem 2410 is referred to as a ‘computation device.’

Memory subsystem 2412 includes one or more devices for storing data and/or instructions for processing subsystem 2410 and networking subsystem 2414. For example, memory subsystem 2412 can include DRAM, static random access memory (SRAM), and/or other types of memory. In some embodiments, instructions for processing subsystem 2410 in memory subsystem 2412 include: one or more program modules or sets of instructions (such as program instructions 2422 or operating system 2424, such as Linux, UNIX, Windows Server, or another customized and proprietary operating system), which may be executed by processing subsystem 2410. Note that the one or more computer programs, program modules or instructions may constitute a computer-program mechanism. Moreover, instructions in the various modules in memory subsystem 2412 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 2410.

In addition, memory subsystem 2412 can include mechanisms for controlling access to the memory. In some embodiments, memory subsystem 2412 includes a memory hierarchy that comprises one or more caches coupled to a memory in electronic device 2400. In some of these embodiments, one or more of the caches is located in processing subsystem 2410.

In some embodiments, memory subsystem 2412 is coupled to one or more high-capacity mass-storage devices (not shown). For example, memory subsystem 2412 can be coupled to a magnetic or optical drive, a solid-state drive, or another type of mass-storage device. In these embodiments, memory subsystem 2412 can be used by electronic device 2400 as fast-access storage for often-used data, while the mass-storage device is used to store less frequently used data.

Networking subsystem 2414 includes one or more devices configured to couple to and communicate on a wired and/or wireless network (i.e., to perform network operations), including: control logic 2416, an interface circuit 2418 and one or more antennas 2420 (or antenna elements). (While FIG. 24 includes one or more antennas 2420, in some embodiments electronic device 2400 includes one or more nodes, such as antenna nodes 2408, e.g., a metal pad or a connector, which can be coupled to the one or more antennas 2420, or nodes 2406, which can be coupled to a wired or optical connection or link. Thus, electronic device 2400 may or may not include the one or more antennas 2420. Note that the one or more nodes 2406 and/or antenna nodes 2408 may constitute input(s) to and/or output(s) from electronic device 2400.) For example, networking subsystem 2414 can include a Bluetooth networking system, a cellular networking system (e.g., a 3G/4G/5G network such as UMTS, LTE, etc.), a universal serial bus (USB) networking system, a coaxial interface, a High-Definition Multimedia Interface (HDMI) interface, a networking system based on the standards described in IEEE 802.11 (e.g., a Wi-Fi® networking system), an Ethernet networking system, a Zigbee networking system, a Z-Wave networking system, a LoRaWAN networking system and/or another networking system.

Note that a transmit or receive antenna pattern (or antenna radiation pattern) of electronic device 2400 may be adapted or changed using pattern shapers (such as directors or reflectors) and/or one or more antennas 2420 (or antenna elements), which can be independently and selectively electrically coupled to ground to steer the transmit antenna pattern in different directions. Thus, if one or more antennas 2420 include N antenna pattern shapers, the one or more antennas may have 2^{N} different antenna pattern configurations. More generally, a given antenna pattern may include amplitudes and/or phases of signals that specify a direction of the main or primary lobe of the given antenna pattern, as well as so-called ‘exclusion regions’ or ‘exclusion zones’ (which are sometimes referred to as ‘notches’ or ‘nulls’). Note that an exclusion zone of the given antenna pattern includes a low-intensity region of the given antenna pattern. While the intensity is not necessarily zero in the exclusion zone, it may be below a threshold, such as 3 dB or lower than the peak gain of the given antenna pattern. Thus, the given antenna pattern may include a local maximum (e.g., a primary beam) that directs gain in the direction of electronic device 2400 that is of interest, and one or more local minima that reduce gain in the direction of other electronic devices that are not of interest. In this way, the given antenna pattern may be selected so that communication that is undesirable (such as with the other electronic devices) is avoided to reduce or eliminate adverse effects, such as interference or crosstalk.

Networking subsystem 2414 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 2400 may use the mechanisms in networking subsystem 2414 for performing simple wireless communication between the electronic devices, e.g., transmitting advertising or beacon frames and/or scanning for advertising frames transmitted by other electronic devices as described previously.

Within electronic device 2400, processing subsystem 2410, memory subsystem 2412, and networking subsystem 2414 are coupled together using bus 2428. Bus 2428 may include an electrical, optical, and/or electro-optical connection that the subsystems can use to communicate commands and data among one another. Although only one bus 2428 is shown for clarity, different embodiments can include a different number or configuration of electrical, optical, and/or electro-optical connections among the subsystems.

In some embodiments, electronic device 2400 includes a display subsystem 2426 for displaying information on a display, which may include a display driver and the display, such as a liquid-crystal display, a multi-touch touchscreen, etc.

Moreover, electronic device 2400 may include a user-interface subsystem 2430, such as: a mouse, a keyboard, a trackpad, a stylus, a voice-recognition interface, and/or another human-machine interface. In some embodiments, user-interface subsystem 2430 may include or may interact with a touch-sensitive display in display subsystem 2426.

Electronic device 2400 can be (or can be included in) any electronic device with at least one network interface. For example, electronic device 2400 can be (or can be included in): a desktop computer, a laptop computer, a subnotebook/netbook, a server, a tablet computer, a cloud-based computing system, a smartphone, a cellular telephone, a smartwatch, a wearable electronic device, a consumer-electronic device, a portable computing device, an access point, a transceiver, a router, a switch, communication equipment, an eNodeB, a controller, test equipment, and/or another electronic device.

Although specific components are used to describe electronic device 2400, in alternative embodiments, different components and/or subsystems may be present in electronic device 2400. For example, electronic device 2400 may include one or more additional processing subsystems, memory subsystems, networking subsystems, and/or display subsystems. Additionally, one or more of the subsystems may not be present in electronic device 2400. Moreover, in some embodiments, electronic device 2400 may include one or more additional subsystems that are not shown in FIG. 24. Also, although separate subsystems are shown in FIG. 24, in some embodiments some or all of a given subsystem or component can be integrated into one or more of the other subsystems or component(s) in electronic device 2400. For example, in some embodiments instructions 2422 is included in operating system 2424 and/or control logic 2416 is included in interface circuit 2418.

Moreover, the circuits and components in electronic device 2400 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’) may implement some or all of the functionality of networking subsystem 2414 and/or of electronic device 2400. The integrated circuit may include hardware and/or software mechanisms that are used for transmitting wireless signals from electronic device 2400 and receiving signals at electronic device 2400 from other electronic devices. Aside from the mechanisms herein described, radios are generally known in the art and hence are not described in detail. In general, networking subsystem 2414 and/or the integrated circuit can include any number of radios. Note that the radios in multiple-radio embodiments function in a similar way to the described single-radio embodiments.

In some embodiments, networking subsystem 2414 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

in some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII) or Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium, Those of skill in the art of integrated circuit fabrication can use such encoded data to fabricate integrated circuits that include one or more of the circuits described herein.

While the preceding discussion used Wi-Fi, MQTT and/or Ethernet communication protocols as illustrative examples, in other embodiments a wide variety of communication protocols and, more generally, communication techniques may be used. Thus, the update techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the update techniques may be implemented using program instructions 2422, operating system 2424 (such as a driver for interface circuit 2418) or in firmware in interface circuit 2418. Alternatively or additionally, at least some of the operations in the update techniques may be implemented in a physical layer, such as hardware in interface circuit 2418.

Furthermore, the functionality of electronic device 2400 may be implemented using a single electronic device or a group of electronic devices, which may be located at a single location or which may be distributed at disparate geographic locations (such as a cloud-based computing system).

Note that the use of the phrases ‘capable of’, ‘capable to,’ ‘operable to,’ or ‘configured to’ in one or more embodiments, refers to some apparatus, logic, hardware, and/or element designed in such a way to enable use of the apparatus, logic, hardware, and/or element in a specified manner.

While examples of numerical values are provided in the preceding discussion, in other embodiments different numerical values are used. Consequently, the numerical values provided are not intended to be limiting.

In the preceding description, we refer to ‘some embodiments.’ Note that ‘some embodiments’ describes a subset of all of the possible embodiments, but does not always specify the same subset of embodiments.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

What is claimed is:

1. A computer system, comprising:
a computation device; and
memory that stores program instructions, wherein, when executed by the computation device, causes the computer system to perform operations comprising:
obtaining data associated with an electronic device, wherein the data has a first format;
computing a context of the data;
based at least in part on the context, identifying the electronic device associated with the data; and
translating, based at least in part on the identified electronic device, the data from the first format to a second format, where the second format is common to additional data associated with multiple different types of electronic devices, and wherein the additional data is stored in or is associated with the computer system.

2. The computer system of claim 1, wherein the computer system comprises an interface circuit configured to communicate with the electronic device, the obtaining comprises receiving the data associated with the electronic device, and the electronic device is at an arbitrary location relative to the computer system, the first format comprises one of a set of formats or both.

3. The computer system of claim 2, wherein the set of formats is associated with multiple different communication protocols.

4. The computer system of claim 1, wherein the context comprises one or more of: a location of the electronic device, a type of the data, a type of the electronic device, the first format, a gateway that forwards the data associated with the electronic device to the computer system.

5. The computer system of claim 1, wherein the identifying is based at least in part on one or more of: an identifier of the electronic device, a subset of the data, a name of the electronic device, or additional data associated with a second electronic device, which is different from the electronic device.

6. The computer system of claim 5, wherein the identifier of the electronic device comprises a media access control (MAC) address or an international mobile subscriber identity (IMSI) number.

7. The computer system of claim 5, wherein the subset of the data comprises a payload in a packet or a frame.

8. The computer system of claim 1, wherein the second format is associated with multiple different applications that provide services based at least in part on the data having the second format.

9. The computer system of claim 1, wherein the operations comprise automatically learning the first format when the electronic device, the data or both have not been previously encountered by the computer system.

10. The computer system of claim 1, wherein one or more of the computing, identifying or translating is performed using a pretrained model.

11. The computer system of claim 10, wherein the pretrained model comprises a machine-learning model or a neural network.

12. The computer system of claim 1, wherein the translating comprises decoding the data.

13. A non-transitory computer-readable storage medium for use in conjunction with a computer system, the computer-readable storage medium storing program instructions, wherein, when executed by the computer system, cause the computer system to perform one or more operations comprising:
obtaining data associated with an electronic device, wherein the data has a first format;
computing a context of the data;
based at least in part on the context, identifying the electronic device associated with the data; and
translating, based at least in part on the identified electronic device, the data from the first format to a second format, where the second format is common to additional data associated with multiple different types of electronic devices, and wherein the additional data is stored in or is associated with the computer system.

14. The computer-readable storage medium of claim 13, wherein the operations comprise receiving the data associated with the electronic device, and
wherein the electronic device is at an arbitrary location relative to the computer system, the first format comprises one of a set of formats or both.

15. The computer-readable storage medium of claim 13, wherein the context comprises one or more of: a location of the electronic device, a type of the data, a type of the electronic device, the first format, a gateway that forwards the data associated with the electronic device to the computer system.

16. The computer-readable storage medium of claim 13, wherein the identifying is based at least in part on one or more of: an identifier of the electronic device, a subset of the data, a name of the electronic device, or additional data associated with a second electronic device, which is different from the electronic device.

17. A method for translating data, comprising:
by a computer system:
obtaining the data associated with an electronic device, wherein the data has a first format;
computing a context of the data;
based at least in part on the context, identifying the electronic device associated with the data; and
translating, based at least in part on the identified electronic device, the data from the first format to a second format, where the second format is common to additional data associated with multiple different types of electronic devices, and wherein the additional data is stored in or is associated with the computer system.

18. The method of claim 17, wherein the method comprises receiving the data associated with the electronic device, and
wherein the electronic device is at an arbitrary location relative to the computer system, the first format comprises one of a set of formats or both.

19. The method of claim 17, wherein the context comprises one or more of: a location of the electronic device, a type of the data, a type of the electronic device, the first format, a gateway that forwards the data associated with the electronic device to the computer system.

20. The method of claim 17, wherein the identifying is based at least in part on one or more of: an identifier of the electronic device, a subset of the data, a name of the electronic device, or additional data associated with a second electronic device, which is different from the electronic device.
